(19) United States
(12) Patent Application Publication
(10) Pub. No.: US 2026/0168955 A1
(43) Pub. Date: Jun. 18, 2026

(54) ELECTROCHEMICAL MICROSENSOR FOR DETECTION OF FLOW PROPERTIES AND METHODS OF USE THEREOF

(71) Applicant: Atlas Data Storage, Inc., South San Francisco, CA (US)

(72) Inventors: Pranav SUNDARAM, South San Francisco, CA (US); Stephen MEHI, San Francisco, CA (US); Anthony DE LA CRUZ, South San Francisco, CA (US); Roger RUDOFF, South San Francisco, CA (US)

(21) Appl. No.: 19/414,844

(22) Filed: Dec. 10, 2025

Related U.S. Application Data
(60) Provisional application No. 63/734,839, filed on Dec. 17, 2024.

(51) Int. Cl. G01N 27/403

(52) U.S. Cl. CPC G01N 27/403

(57) ABSTRACT

Described herein are electrochemical chips for use as multipurpose sensors to detect fill conditions, such as liquid level, fill percentage, and more, inside of a flow cell assembly during oligonucleotide synthesis. Also described herein are flow cell assemblies incorporating the electrochemical chips for use in monitoring, evaluating, and optimizing oligonucleotide synthesis. Also described herein are methods of using the flow cell assemblies during and after oligonucleotide synthesis.

### CROSS-REFERENCE TO RELATED APPLICATION

This application claims priority to and the benefit of U.S. Provisional Application No. 63/734,839, filed Dec. 17, 2024, and entitled “Electrochemical Microsensor for Detection of Flow Properties and Methods of Use Thereof,” the disclosure of which is hereby incorporated by reference herein in its entirety.

### TECHNICAL FIELD

Embodiments described herein relate to systems, devices, and methods for detecting flow properties. More specifically, embodiments described herein relate to electrochemical chips including sensors for detecting flow properties during biomolecule synthesis.

### BACKGROUND

Instruments and liquid delivery systems used in oligonucleotide synthesis typically use individual, dedicated hardware such as flowmeters, liquid level sensors, and optical sensors to detect flow properties during operation. The implementation and coordination of multiple dedicated hardware units can increase complexity, cost, and opportunities for error associated with oligonucleotide synthesis. Accordingly, there exists a need for improved flowmeters, liquid level sensors, and optical sensors for use in oligonucleotide synthesis.

### SUMMARY

In some embodiments, a method of determining conditions of an electrochemical chip comprising a plurality of reaction sites, including: delivering a diluent to a flow cell assembly comprising the electrochemical chip; for each reaction site of the plurality of reaction sites, measuring a background current; delivering an electrochemically reactive solution to the flow cell assembly; for each reaction site of the plurality of reaction sites, applying a voltage pulse; and for each reaction site of the plurality of reaction sites, measuring a current corresponding to the reaction site.

In some embodiments, a flow cell assembly for oligonucleotide synthesis includes: a flow cell bottom; a flow cell top in contact with the flow cell bottom; and an electrochemical chip situated in a recess in the flow cell bottom, wherein the electrochemical chip comprises a plurality of reaction sites, wherein each reaction site comprises a microwell comprising two electrodes, the two electrodes configured to deliver voltage to and measure current from the reaction site; an electrical connection configured to transmit a signal to and/or from the electrochemical chip; and a flow cell top in contact with the flow cell bottom, wherein the flow cell top comprises an aperture configured to receive the electrical connection.

In some embodiments, a system includes: a flow cell including an electrochemical chip, the electrochemical chip including a plurality of reaction sites arranged in one or more parallel rows, each reaction site of the plurality of reaction sites including a microwell configured to receive a fluid; and a computing device operatively coupled to the electrochemical chip, the computing device configured to: selectively deliver electrical input to an electrode at each reaction site of the plurality of reaction sites; and selectively receive electrical input from the electrode at each reaction site of the plurality of reaction sites to determine at least one of a liquid level, a fill percentage, or a flow rate of the fluid inside of the flow cell.

### BRIEF DESCRIPTION OF THE DRAWINGS

Embodiments of the present disclosure may be implemented in connection with aspects illustrated in the attached drawings. These drawings show different aspects of the present disclosure, and where appropriate, reference numerals illustrating like structures, components, materials, and/or elements in different figures are labeled similarly. It is understood that various combinations of the structures, components, and/or elements, other than those specifically shown, are contemplated and are within the scope of the present disclosure. For simplicity and clarity of illustration, the figures depict the general structure and/or manner of construction of the various embodiments/aspects described herein.

FIG. 1 is a schematic representation of an exemplary electrochemical chip, according to some embodiments.

FIG. 2 is an exploded view of an exemplary flow cell assembly, including a flow cell top, an electrochemical chip, and a flow cell bottom, according to some embodiments.

FIG. 3 is a schematic representation of the exemplary flow cell assembly of FIG. 2 in a fully-assembled state, according to some embodiments.

FIG. 4A is an illustration depicting a front view of a flow cell top of an exemplary flow cell assembly, according to some embodiments.

FIG. 4B is an illustration depicting a rear view of a flow cell top of an exemplary flow cell assembly, according to some embodiments.

FIG. 4C is an illustration depicting a front view of a flow cell bottom of an exemplary flow cell assembly, according to some embodiments.

FIG. 4D is an illustration depicting a rear view of a flow cell bottom of an exemplary flow cell assembly, according to some embodiments.

FIG. 5 is a schematic representation of an exemplary flow cell, according to some embodiments.

FIG. 6 is a schematic representation of an exemplary fluid delivery pathway within a flow cell assembly, according to some embodiments.

FIG. 7 is a schematic representation of an exemplary flow cell assembly in a tilted orientation, according to some embodiments.

FIG. 8 is a line graph with origin-normalized, zero-corrected area under the curve (AUC) current values plotted versus fill difference from origin for various conditions, according to some embodiments.

FIG. 9 is a plot depicting various conditions for a 10 μL fill experiment performed on an exemplary electrochemical chip, according to some embodiments.

FIG. 10 is a plot for a time variance experiment performed on an exemplary electrochemical chip, according to some embodiments.

FIG. 11A is a scatter plot depicting normalized, zero-corrected current values as a function of row number for a generic fill condition, according to some embodiments.

FIG. 11B is a four-parameter symmetric-sigmoidal curve fit to the data of FIG. 11A, according to some embodiments.

FIG. 12 is a scatter plot including back-calculated volume differentials for every 0.5 μL fill increment from origin for an exemplary electrochemical chip, according to some embodiments.

FIG. 13 is a line graph depicting origin-normalized, zero-corrected area under the curve (AUC) current values plotted versus fill difference from origin for various conditions, according to some embodiments.

FIG. 14 is a line graph depicting average origin-normalized, zero-corrected area under the curve (AUC) current values plotted versus fill difference from origin for various conditions using two exemplary electrochemical chips, according to some embodiments.

FIG. 15 is a line graph depicting average origin-normalized, zero-corrected area under the curve (AUC) current values plotted versus fill difference from origin for various conditions, according to some embodiments.

FIG. 16 is a line graph depicting average origin-normalized, zero-corrected area under the curve (AUC) current values plotted versus fill difference from origin for various conditions, according to some embodiments.

FIG. 17 is a plot depicting current-generating rows as a function of total current for a 10 μL fill experiment performed on an exemplary electrochemical chip, according to some embodiments.

FIG. 18 is a plot depicting a time variance experiment performed on an exemplary electrochemical chip, according to some embodiments.

FIG. 19 is a line graph depicting a comparison of averaged area under the curve (AUC) current data for various fill increments performed on two exemplary electrochemical chips, according to some embodiments.

FIG. 20 is an illustration depicting an exemplary electrochemical chip in a flow cell containing no electrochemically reactive reagent to obtain a zero-current reading with corresponding exemplary current readings, according to some embodiments.

FIG. 21 is an illustration depicting an exemplary electrochemical chip in a flow cell with baseline fill to obtain a baseline fill reading (e.g., an origin point) and corresponding exemplary current readings, according to some embodiments.

FIG. 22 is an illustration depicting a 20 μL fill above origin point of an exemplary electrochemical chip in a flow cell with corresponding exemplary current readings, according to some embodiments.

FIG. 23 is an illustration depicting a 40 μL fill above origin point of an exemplary electrochemical chip in a flow cell with corresponding exemplary current readings, according to some embodiments.

FIG. 24 is an illustration depicting an exemplary electrochemical chip in a fully-filled flow cell with corresponding exemplary current readings, according to some embodiments.

FIG. 25 is an illustration depicting an exemplary electrochemical chip in a flow cell with corresponding exemplary current readings at an initial time point (e.g., t₀), according to some embodiments.

FIG. 26 is an illustration depicting an exemplary electrochemical chip in a flow cell with corresponding exemplary current readings at a time point (e.g., t=700 ms) for a continuous fill measurement, according to some embodiments.

FIG. 27 is an illustration depicting an exemplary electrochemical chip in a flow cell with corresponding exemplary current readings at a time point (e.g., t=945 ms) for a continuous fill measurement, according to some embodiments.

FIG. 28 is an illustration depicting an exemplary electrochemical chip in a flow cell with corresponding exemplary current readings at a time point (e.g., t=1,500 ms) for a continuous fill measurement, according to some embodiments.

FIG. 29A is a scatter plot depicting area under the curve (AUC) current values for total current as a function of DAC Row number for an exemplary electrochemical chip in a zero-current condition, according to some embodiments.

FIG. 29B is a scatter plot depicting total current values as a function of DAC Row number at a time point (e.g., t=710 ms) for an exemplary electrochemical chip in a partial fill condition, according to some embodiments.

FIG. 30A is a graph depicting average zero-corrected AUC current values (μA) as a function of time for various fill rates on an exemplary electrochemical chip, according to some embodiments.

FIG. 30B is a graph depicting average normalized, zero-corrected AUC current values (μA) as a function of time for various fill rates on an exemplary electrochemical chip, according to some embodiments.

FIG. 31 is a graph depicting a calibration plot for a time point corresponding to 99% saturation as a function of fill rate for an exemplary electrochemical chip, according to some embodiments.

FIG. 32 is a graph depicting normalized, zero-corrected AUC current values (μA) as a function of time for various known and unknown fill rates on an exemplary electrochemical chip, according to some embodiments.

FIG. 33 is a graph depicting normalized, zero-corrected AUC current values (μA) as a function of time for various fill rates from two runs for an exemplary electrochemical chip, according to some embodiments.

FIG. 34 is a graph depicting a calibration plot for a time point corresponding to 99% saturation for an exemplary electrochemical chip, according to some embodiments.

FIG. 35 is a graph depicting a comparison of calibration plots for time points corresponding to 99% saturation as a function of fill rate for two exemplary electrochemical chips, according to some embodiments.

FIG. 36 is an illustration depicting an exemplary electrochemical chip in a zero current condition in a flow cell, according to some embodiments.

FIG. 37 is an illustration depicting an exemplary electrochemical chip in a partial fill state, according to some embodiments.

FIG. 38 is an illustration depicting an exemplary electrochemical chip in a fully-filled state, according to some embodiments.

FIG. 39A is a graph including a plot of total current as a function of row number in an exemplary electrochemical chip corresponding to a partial fill state in a flow cell, according to some embodiments.

FIG. 39B is a graph including a plot of total current as a function of row number in an exemplary electrochemical chip corresponding to a partial fill state in a flow cell, according to some embodiments.

FIG. 39C is a graph including a plot of total current as a function of row number in an exemplary electrochemical chip corresponding to a fully-filled state in a flow cell, according to some embodiments.

FIG. 40A is a graph including a plot of total current as a function of row number in an exemplary electrochemical chip corresponding to a partial fill state in a flow cell, according to some embodiments.

FIG. 40B is a graph including a plot of total current as a function of row number in an exemplary electrochemical chip corresponding to a partial fill state in a flow cell, according to some embodiments.

FIG. 40C is a graph including a plot of total current as a function of row number in an exemplary electrochemical chip corresponding to fully-filled state in a flow cell, according to some embodiments.

FIG. 41 is an illustration depicting difference in directional order for liquid flow and voltage application rows for electrochemical chips in a flow cell assembly in a vertical orientation and a flow cell assembly in a tilted orientation, according to some embodiments.

FIG. 42 is an illustration depicting an exemplary electrochemical chip in a tilted flow cell orientation and in a zero-current condition, according to some embodiments.

FIG. 43 is an illustration depicting an exemplary electrochemical chip of FIG. 43 in a tilted flow cell orientation and in a baseline fill (e.g., an origin point) condition, according to some embodiments

FIG. 44 is an illustration depicting an exemplary electrochemical chip of FIG. 43 in a tilted flow cell orientation and in a partial fill condition, according to some embodiments.

FIG. 45 is an illustration depicting an exemplary electrochemical chip of FIG. 43 in a tilted flow cell orientation and in a partial fill condition, according to some embodiments

FIG. 46 is an illustration depicting an exemplary electrochemical chip of FIG. 43 in a tilted flow cell orientation and in a partial fill condition, according to some embodiments.

FIG. 47 is an illustration depicting an exemplary electrochemical chip of FIG. 43 in a tilted flow cell orientation and in a partial fill condition, according to some embodiments.

FIG. 48 is an illustration depicting an exemplary electrochemical chip of FIG. 43 in a tilted flow cell orientation and in a fully-filled condition, according to some embodiments.

FIG. 49A is an illustration depicting origin point conditions of an exemplary electrochemical chip in a vertical flow cell orientation, according to some embodiments.

FIG. 49B is an illustration depicting origin point conditions of an exemplary electrochemical chip in a tilted flow cell orientation, according to some embodiments.

FIG. 50 is a graph depicting average normalized, zero-corrected AUC current values for various fill increments as a function of fill difference from origin, from an exemplary electrochemical chip in a tilted flow cell orientation, according to some embodiments

FIG. 51 is a histogram plot including the results of a fill experiment performed on an exemplary electrochemical chip in a tilted flow cell orientation, according to some embodiments.

FIG. 52 is a histogram plot including the results of a time variance experiment performed on an exemplary electrochemical chip in a tilted flow cell orientation, according to some embodiments.

FIG. 53 is a graph comparing average area under the curve (AUC) current values for various fill increments performed using an exemplary electrochemical chip in a vertical flow cell orientation and a tilted flow cell orientation, according to some embodiments.

FIG. 54 is a graph depicting total current values as a function of DAC Row number of an exemplary electrochemical chip in a tilted flow cell orientation, according to some embodiments.

FIG. 55 is a graph depicting total current values as a function of DAC Row number of an exemplary electrochemical chip in a tilted flow cell orientation, according to some embodiments.

### DETAILED DESCRIPTION

There are many embodiments described and illustrated herein. The present disclosure is neither limited to any single aspect nor embodiment thereof, nor to any combinations and/or permutations of such aspects and/or embodiments. Moreover, each aspect of the present disclosure, and/or embodiments thereof, may be employed alone or in combination with one or more other aspects of the present disclosure and/or embodiments thereof. For the sake of brevity, certain permutations and combinations are not discussed and/or illustrated separately herein. Notably, an embodiment or implementation described herein as “exemplary” is not to be construed as preferred or advantageous, for example, over other embodiments or implementations; rather, it is intended to reflect or indicate that the embodiment(s) is/are “example” embodiment(s).

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

As used herein, the term “approximately” is meant to account for variations due to experimental error. When applied to numeric values, the terms “about” and “approximately” may indicate a variation of +/−5% from the disclosed numeric value, unless a different variation is specified. When applied to angle measures, the terms “about” and “approximately” may indicate a variation of +/−3°. As used herein, the singular forms “a,” “an,” and “the” include plural referents unless the context clearly dictates otherwise. Further, all ranges are understood to be inclusive of endpoints, e.g., from 1 nanometer (nm) to 5 nm may include lengths of 1 nm, 5 nm, and all distances between 1 nm and 5 nm.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03

The present disclosure describes a single electrochemical chip capable of converting a chemical reaction to electrical output to perform the function of three separate sensors to detect liquid level inside a flow cell at a sub-millimeter level, flowrate of a reagent over a substrate, and fill percentage inside the flow cell during oligonucleotide synthesis.

The multipurpose sensor functionality of the electrochemical chip allows for direct probing at the site of oligonucleotide synthesis, yielding an unprecedented level of insight into the conditions affecting synthesis. With increased response times as compared to fluidics, the electrochemical chip can capture transient aspects of microscale phenomena. Moreover, the reduction in physical hardware needed to perform unique sensor tasks corresponds to a generous reduction in cost, complexity, maintenance, and calibration.

Provided herein are electrochemical chips for use as multipurpose sensors to detect liquid level, flow rate, and fill percentage during oligomer synthesis on a substrate. Also provided herein are flow cells and systems incorporating the electrochemical chips, and methods of assembling and using the same.

All definitions, as defined and used herein, should be understood to control over dictionary definitions, definitions in documents incorporated by reference, and/or ordinary meanings of the defined terms.

Unless defined otherwise, all technical and scientific terms used herein have the same meaning as is commonly understood by one of ordinary skill in the art to which these embodiments described herein belong.

Throughout this disclosure, numerical features are presented in a range format. It should be understood that the description in range format is merely for convenience and brevity and should not be construed as an inflexible limitation on the scope of any embodiments. Accordingly, the description of a range should be considered to have specifically disclosed all the possible subranges as well as individual numerical values within that range to the tenth of the unit of the lower limit unless the context clearly dictates otherwise. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual values within that range, for example, 1.1, 2, 2.3, 5, and 5.9. This applies regardless of the breadth of the range. The upper and lower limits of these intervening ranges may independently be included in the smaller ranges, and are also encompassed within the embodiments described herein, subject to any specifically excluded limit in the stated range. Where the stated range includes one or both of the limits, ranges excluding either or both of those included limits are also included in the embodiments described herein, unless the context clearly dictates otherwise.

As used herein, the terms “oligonucleotide,” “oligo,” “oligonucleic acid,” “nucleic acid molecule,” and “polynucleotide” may refer to a polymer molecule of nucleoside monomers. Such oligonucleotides may be connected via phosphate linkages or sulfur-containing linkages, and may comprise deoxyribonucleic acids (DNA), ribonucleic acids (RNA), non-canonical nucleic acids or bases, unnatural or synthetic nucleic acids, or other nucleosides, as well as sugars or other moieties. Such oligonucleotides may further comprise terminators configured to prevent extension reactions, and which may be removed before addition of subsequent nucleotides to a growing oligonucleotide chain.

As used herein, “pitch size” may refer to a distance between adjacent reaction sites (e.g., microelectrodes, reaction wells, microwells) on an electrochemical chip, as described herein. For example, as described herein, the electrochemical chip may include one or more parallel rows of reaction sites. Pitch size may refer to a distance between adjacent parallel rows and/or a distance between reaction sites within the same row. Some groups of reaction sites that are shown in the figures in a horizontal configuration may be referred to as rows, and some groups of reaction sites that are shown in the figures in a vertical configuration may be referred to as columns. However, the operation of the digital chips and flow cells described herein are independent of the orientation of the chips and flow cells. Accordingly, a group of reaction sites may be referred to as either columns or rows, regardless of the orientation of the group to a gravitational plane (i.e., a plane normal to gravitational vectors).

As used herein, a “Digital to Analog Converter group,” “DAC group,” or “DAC” may refer to an electronic device or component capable of converting a digital signal into an analog signal. An “Analog to Digital Converter group,” “ADC group,” or “ADC” may be a device or component capable of converting an analog signal into a digital signal.

As used herein, “flow cell” may refer to a slide, platform, or other structure comprising one or more channels configured to receive and pass fluids. The flow cell may include one or more surfaces that are coupled to one or more oligonucleotides, and may be used in the production and/or sequencing of synthetic oligonucleotides. A “Hele-Shaw flow cell” may refer to a flow cell where a height of a reagent cavity in the flow cell is smaller than a length and/or a width of the flow cell.

Electrochemical chips may be used in flow cell assemblies and systems including the same. For example, the electrochemical chips may be used as substrates for oligonucleotide synthesis and/or multipurpose sensors. In some embodiments, an electrochemical chip may be used as a sensor to sense liquid level, flow rate, and/or fill percentage. For example, an electrochemical chip may be used to sense liquid level, flow rate, and/or fill percentage during oligonucleotide synthesis.

In some embodiments, the electrochemical chip may include a silicon chip. In some embodiments, the electrochemical chip may include one or more surfaces functionalized for association with a building block of an oligonucleotide molecule. The building block may include a nucleotide, a dinucleotide, a trinucleotide, and/or another polynucleotide. In addition or alternatively, the building block may include a sugar, a nitrogenous base, a phosphate, or a combination thereof. In some embodiments, the building block may include a nitrogenous base protected with a suitable protecting group and/or blocking group. In addition or alternatively, the building block may include a sugar protected using a suitable protecting group and/or blocking group.

The electrochemical chip provided herein may include a plurality of reaction sites each of which may be the site of an electrochemical reaction. The reaction sites may be arranged within an active area of the electrochemical chip.

An electrochemical reaction, such as those occurring on an electrochemical chip, may be facilitated by an electrochemically reactive solution. The electrochemically reactive solution may include an aqueous solution. The electrochemically reactive solution may include one or more reduction reactants, one or more oxidation reactants, one or more bases, one or more electrolytes, one or more diluent, or a combination thereof.

A reduction reactant of the electrochemically reactive solution may include a reactant capable of receiving one or more electrode, such as, for example, receiving one or more electrodes from a cathode. The electrochemically reactive solution may include greater than or equal to approximately 1 mM, and/or less than or equal to approximately 25 mM, of the one or more reduction reactants. For example, the electrochemically reactive solution may include approximately 1 mM to approximately 15 mM, approximately 5 mM to approximately 25 mM, approximately 5 mM to approximately 15 mM, or approximately 10 mM of the one or more reduction reactants. The one or more reduction reactants may include benzoquinone, quinone derivatives, p-benzoquinone, 2,5-di-tert-butylbenzoquinone, tetrachloro-1,4-benzoquinone, tetrafluoro-1,4-benzoquinone, 2,5-dichloro-benzoquinone, 2,3-dimethoxy-5-methyl-p-benzoquinone, 2,6-diaminoanthraquinone, hexaketocyclohexane, 2,3-dichloro-5,6-dicyano-p-benzoquinone, ferricyanide, ferrocenium ion, or ferrocenemethanol.

An oxidation reactant of the electrochemically reactive solution may include a reactant capable of donating one or more electrodes, such as, for example, donating one or more electrodes to an anode. The electrochemically reactive solution may include greater than or equal to 250 mM, and/or less than or equal to 1.0 M, of the one or more oxidation reactants. For example, the electrochemically reactive solution may include approximately 250 mM to approximately 1.0 M, approximately 250 mM to approximately 750 mM, approximately 250 mM to approximately 500 mM, approximately 500 mM to approximately 750 mM, or approximately 500 mM of the one or more oxidation reactants. The one or more oxidation reactants may include hydroquinone, 2,5-di-tert-butylhydroquinone, tetrachloro-hydroquinone, tetrafluoro-hydroquinone, hexahydroxy benzene, ferrocyanide, and/or ferrocene.

In some embodiments, the one or more reduction reactants and one or more oxidation reactants of the electrochemically reactive solution may be paired redox reactants. For example, a reduction reactant (e.g., p-benzoquinone), after accepting one or more electrodes, may become the oxidation reactant (e.g., hydroquinone). Similarly, the oxidation reactant (e.g., hydroquinone), after donating one or more electrodes, may become the reduction reactant (e.g., p-benzoquinone). The electrochemically reactive solution may include a concentration of oxidation reactants that may be greater than a concentration of reduction reactants in the electrochemically reactive solution. For example, the concentration of oxidation reactants in the electrochemically reactive solution may be at least 10 times, at least 20 times, or at least 50 times the concentration of the reduction reactants in the electrochemically reactive solution. In some embodiments, methods of the present disclosure may be successfully performed with ionic species, and not paired reduction and oxidation reactants.

The one or more bases of the electrochemically reactive solution may reduce, inhibit, and/or prevent the occurrence of acid-quenching reactions near an electrode (e.g., an anode). The electrochemically reactive solution may include greater than or equal to approximately 0.1 mM, and/or less than or equal to approximately 10 mM, of the one or more bases. For example, the electrochemically reactive solution may include about 0.1 mM, about 0.2 mM, about 0.3 mM, about 0.4 mM, about 0.5 mM, about 0.6 mM, about 0.7 mM, about 0.8 mM, about 0.9 mM, about 1 mM, about 2 mM, about 5 mM, or about 10 mM, of the one or more bases. The one or more bases may include 2,6-lutidine, N, N-diisopropylethylamine (DIPEA), 1,8-diazabicyclo[5.4.0]undec-7-ene (DBU), or pyridine.

The one or more electrolytes of the electrochemically reactive solution may facilitate ion transport between electrodes (e.g., ion transport between a cathode and an anode). The electrochemically reactive solution may include greater than or equal to 5 mM, and/or less than or equal to 50 mM, of the one or more electrolytes. For example, the electrochemically reactive solution may include about 5 mM to about 25 mM, about 10 mM to about 25 mM, about 10 to about 20 mM, about 15 mM to about 25 mM, or about 15 mM to about 20 mM, of the one or more electrolytes. The one or more electrolytes may be non-corrosive with regard to electrode material. The one or more electrolytes may include tetrabutylammonium hexafluorophosphate (TBAPF₆), tetraalkylammonium hexafluorophosphate, tetraalkylammonium paratoluene sulfonate, tetrafluoroborate, tetraphenylborate, perchlorate, tetrachloroferrate, hexafluoroarsenate, potassium chloride, silver chloride, or sulfate.

The electrochemically reactive solution may include one or more diluents. The one or more diluents may constitute the bulk of the electrochemically reactive solution. A diluent may be selected such that the other components of the electrochemically reactive solution are soluble in the electrochemically reactive solution. The one or more diluents may be a liquid, such as, for example, a liquid that is not electrically conductive. The one or more diluents may be non-corrosive, or otherwise inert to electrode materials at the reaction site. The one or more diluents may include water, acetonitrile, methanol, ethanol, dichloromethane, chloroform, dimethylformamide, ethylene glycol, or propylene carbonate.

In one or more embodiments, the electrochemically reactive solution may include about 10 mM p-benzoquinone, about 500 mM hydroquinone, about 0.5 mM 2,6-lutidine, about 17 mM TBAPF₆, in an acetonitrile solution.

The electrochemically reactive solution described herein may allow for completion of a current-carrying circuit at a reaction site on an electrochemical chip. In some embodiments, a reaction site of an electrochemical chip may include a microwell including two electrodes. The two electrodes may include an anode and a cathode. In addition or alternatively, the microwell may include other electrode architectures, e.g., planar 2D electrodes. An electrochemical reaction may occur at the reaction site (e.g., in a microwell). For example, an electrochemical reaction may occur as a result of application of a voltage pulse to electrodes of the reactive site. The electrochemical reaction may result in the transfer of one or more electrons from a cathode to one or more components of the electrochemically reactive solution (e.g., a reduction reactant). In addition or alternatively, the electrochemical reaction may result in the transfer of one or more electrodes from one or more components of the electrochemically reactive solution (e.g., an oxidation reactant) to an anode. The net current of each reaction site or a subset of reaction sites may be measured and/or recorded.

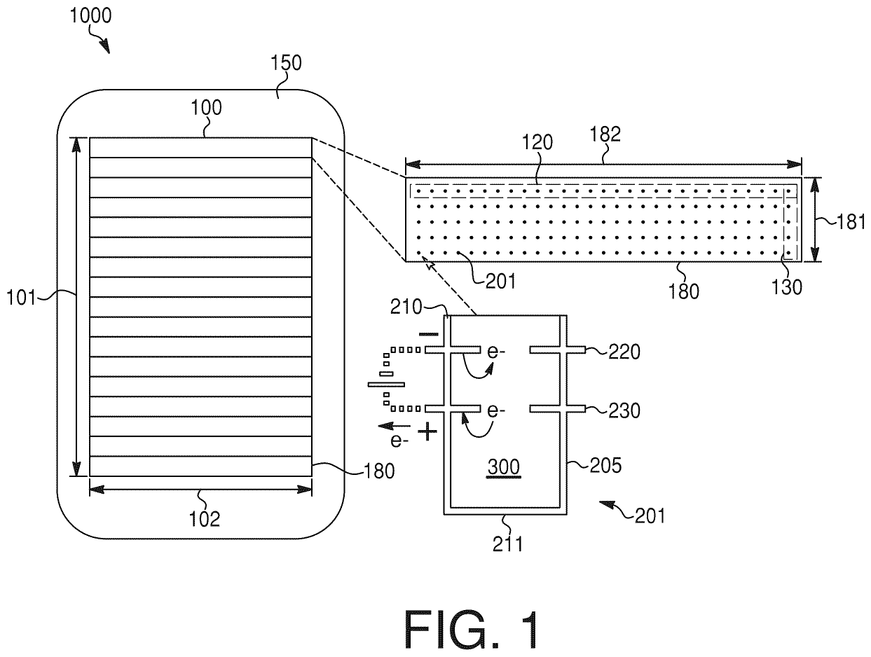

Referring to FIG. 1, an electrochemical chip 1000 may include an active area 100 and an inactive area 150. In some embodiments, the inactive area 150 may surround the active area 100. The active area 100 may be substantially rectangular. Although the electrochemical chip 1000 shown in FIG. 1 includes a rectangular active area 100, active area 100 may be in any shape, such as, for example, a circle, an ellipse, or any other contiguous region or group of contiguous regions. Portions of the inactive area 150 may extend past one or more edges of active area 100. In some embodiments, electrochemical chip 1000 may include more than one active area 100 that are separated by portions of inactive area 150.

Active area 100 may have a first length 101 and a second length 102. The first length 101 may be greater than or equal to about 15 mm, and/or less than or equal to about 50 mm. For example, the first length 101 may be about 15 mm to about 16 mm, about 15 mm to about 17 mm, about 15 mm to about 18 mm, about 15 mm to about 19 mm, about 15 mm to about 20 mm, about 15 mm to about 21 mm, about 15 mm to about 22 mm, about 15 mm to about 25 mm, about 15 mm to about 28 mm, about 15 mm to about 30 mm, about 15 mm to about 32 mm, about 15 mm to about 35 mm, about 15 mm to about 38 mm, about 15 mm to about 40 mm, about 18 mm to about 19 mm, about 18 mm to about 20 mm, about 18 mm to about 21 mm, about 18 mm to about 22 mm, about 18 mm to about 25 mm, about 18 mm to about 28 mm, about 18 mm to about 30 mm, about 18 mm to about 32 mm, about 18 mm to about 35 mm, about 18 mm to about 38 mm, about 18 mm to about 40 mm, about 20 mm to about 21 mm, about 20 mm to about 22 mm, about 20 mm to about 25 mm, about 20 mm to about 28 mm, about 20 mm to about 30 mm, about 20 mm to about 32 mm, about 20 mm to about 35 mm, about 20 mm to about 38 mm, about 20 mm to about 40 mm, about 25 mm to about 28 mm, about 25 mm to about 30 mm, about 25 mm to about 32 mm, about 25 mm to about 35 mm, about 25 mm to about 38 mm, about 25 mm to about 40 mm, about 30 mm to about 32 mm, about 30 mm to about 35 mm, about 30 mm to about 40 mm, about 35 mm to about 40 mm, about 15 mm, about 15.5 mm, about 16 mm, about 16.5 mm, about 17 mm, about 17.5 mm, about 18 mm, about 18.5 mm, about 19 mm, about 19.5 mm, about 20 mm, about 20.5 mm, about 21 mm, about 21.5 mm, about 22 mm, about 25 mm, about 28 mm, about 30 mm, about 32 mm, about 35 mm, about 38 mm, about 40 mm, greater than or equal to about 15 mm, greater than or equal to about 15.5 mm, greater than or equal to about 16 mm, greater than or equal to about 16.5 mm, greater than or equal to about 17 mm, greater than or equal to about 17.5 mm, greater than or equal to about 18 mm, greater than or equal to about 18.5 mm, greater than or equal to about 19 mm, greater than or equal to about 19.5 mm, greater than or equal to about 20 mm, greater than or equal to about 20.5 mm, greater than or equal to about 21 mm, greater than or equal to about 21.5 mm, greater than or equal to about 22 mm, greater than or equal to about 25 mm, greater than or equal to about 28 mm, greater than or equal to about 30 mm, greater than or equal to about 32 mm, greater than or equal to about 35 mm, greater than or equal to about 38 mm, greater than or equal to about 40 mm, less than or equal to about 15.5 mm, less than or equal to about 16 mm, less than or equal to about 16.5 mm, less than or equal to about 17 mm, less than or equal to about 17.5 mm, less than or equal to about 18 mm, less than or equal to about 18.5 mm, less than or equal to about 19 mm, less than or equal to about 19.5 mm, less than or equal to about 20 mm, less than or equal to about 20.5 mm, less than or equal to about 21 mm, less than or equal to about 21.5 mm, less than or equal to about 22 mm, less than or equal to about 25 mm, less than or equal to about 28 mm, less than or equal to about 30 mm, less than or equal to about 32 mm, less than or equal to about 35 mm, less than or equal to about 38 mm, or less than or equal to about 40 mm.

The second length 102 may be greater than or equal to about 15 mm, and/or less than or equal to about 50 mm. For example, the second length 102 may be about 15 mm to about 16 mm, about 15 mm to about 17 mm, about 15 mm to about 18 mm, about 15 mm to about 19 mm, about 15 mm to about 20 mm, about 15 mm to about 21 mm, about 15 mm to about 22 mm, about 15 mm to about 25 mm, about 15 mm to about 28 mm, about 15 mm to about 30 mm, about 15 mm to about 32 mm, about 15 mm to about 35 mm, about 15 mm to about 38 mm, about 15 mm to about 40 mm, about 18 mm to about 19 mm, about 18 mm to about 20 mm, about 18 mm to about 21 mm, about 18 mm to about 22 mm, about 18 mm to about 25 mm, about 18 mm to about 28 mm, about 18 mm to about 30 mm, about 18 mm to about 32 mm, about 18 mm to about 35 mm, about 18 mm to about 38 mm, about 18 mm to about 40 mm, about 20 mm to about 21 mm, about 20 mm to about 22 mm, about 20 mm to about 25 mm, about 20 mm to about 28 mm, about 20 mm to about 30 mm, about 20 mm to about 32 mm, about 20 mm to about 35 mm, about 20 mm to about 38 mm, about 20 mm to about 40 mm, about 25 mm to about 28 mm, about 25 mm to about 30 mm, about 25 mm to about 32 mm, about 25 mm to about 35 mm, about 25 mm to about 38 mm, about 25 mm to about 40 mm, about 30 mm to about 32 mm, about 30 mm to about 35 mm, about 30 mm to about 40 mm, about 35 mm to about 40 mm, about 15 mm, about 15.5 mm, about 16 mm, about 16.5 mm, about 17 mm, about 17.5 mm, about 18 mm, about 18.5 mm, about 19 mm, about 19.5 mm, about 20 mm, about 20.5 mm, about 21 mm, about 21.5 mm, about 22 mm, about 25 mm, about 28 mm, about 30 mm, about 32 mm, about 35 mm, about 38 mm, about 40 mm, greater than or equal to about 15 mm, greater than or equal to about 15.5 mm, greater than or equal to about 16 mm, greater than or equal to about 16.5 mm, greater than or equal to about 17 mm, greater than or equal to about 17.5 mm, greater than or equal to about 18 mm, greater than or equal to about 18.5 mm, greater than or equal to about 19 mm, greater than or equal to about 19.5 mm, greater than or equal to about 20 mm, greater than or equal to about 20.5 mm, greater than or equal to about 21 mm, greater than or equal to about 21.5 mm, greater than or equal to about 22 mm, greater than or equal to about 25 mm, greater than or equal to about 28 mm, greater than or equal to about 30 mm, greater than or equal to about 32 mm, greater than or equal to about 35 mm, greater than or equal to about 38 mm, greater than or equal to about 40 mm, less than or equal to about 15.5 mm, less than or equal to about 16 mm, less than or equal to about 16.5 mm, less than or equal to about 17 mm, less than or equal to about 17.5 mm, less than or equal to about 18 mm, less than or equal to about 18.5 mm, less than or equal to about 19 mm, less than or equal to about 19.5 mm, less than or equal to about 20 mm, less than or equal to about 20.5 mm, less than or equal to about 21 mm, less than or equal to about 21.5 mm, less than or equal to about 22 mm, less than or equal to about 25 mm, less than or equal to about 28 mm, less than or equal to about 30 mm, less than or equal to about 32 mm, less than or equal to about 35 mm, less than or equal to about 38 mm, or less than or equal to about 40 mm.

As described above, the electrochemical chip 1000 may include a plurality of reaction sites 201 arranged within an active area 100 of the electrochemical chip 1000. Active area 100 may be divided into a plurality of blocks 180. As described in greater detail below, each block 180 may include a DAC Group. Each block 180 may have a block length 181 and a block width 182. The plurality of reaction sites 201 may be evenly distributed along block length 181. In addition or alternatively, the plurality of reaction sites 201 may be evenly distributed along block width 182. For example, reaction sites 201 may be arranged in an array of rows 120 and columns 130, wherein each row 120 of reaction sites 201 may be evenly spaced along block length 181 and each column 130 of reaction sites 201 may be evenly spaced along block width 182. A pitch between adjacent reaction sites 201 in the same row 120 may be greater than or equal to approximately 0.1 μm and/or less than or equal to approximately 3.0 μm. For example, a pitch between adjacent reaction sites 201 in the same row 120 may be approximately 0.1 μm to approximately 2.0 μm, approximately 0.1 μm to approximately 1.5 μm, approximately 0.1 μm to approximately 1 μm, approximately 0.5 μm to approximately 2.5 μm, approximately 0.5 μm to approximately 2.0 μm, approximately 0.5 μm to approximately 1.5 μm, approximately 1.0 μm to approximately 2.0 μm, approximately 0.5 μm to approximately 1.0 μm, or approximately 1 μm. A pitch between adjacent reaction sites 201 in the same column 130 may be greater than or equal to approximately 0.1 μm and/or less than or equal to approximately 3.0 μm. For example, a pitch between adjacent reaction sites 201 in the same column 130 may be approximately 0.1 μm to approximately 2.0 μm, approximately 0.1 μm to approximately 1.5 μm, approximately 0.1 μm to approximately 1 μm, approximately 0.5 μm to approximately 2.5 μm, approximately 0.5 μm to approximately 2.0 μm, approximately 0.5 μm to approximately 1.5 μm, approximately 1.0 μm to approximately 2.0 μm, approximately 0.5 μm to approximately 1.0 μm, or approximately 1 μm. Within a block 180, a pitch between adjacent reaction sites 201 in the same row 120 may be greater than, equal to, or less than a pitch between adjacent reaction sites 201 in the same column 130.

Each reaction site 201 may include a microwell. The microwell may be configured to retain diluent and/or an electrochemically reactive solution 300. The microwell may include a bottom surface 211 and an opening 210. Opening 210 may be opposite bottom surface 211. The bottom surface 211 and opening 210 of each microwell may be connected by a side wall 205. Opening 210 may be configured to receive electrochemically reactive solution 300. The microwell may include two electrodes. For example, the microwell may include electrodes disposed along side wall 205. The two electrodes may include an anode 230 and a cathode 220. A distance between anode 230 and bottom surface 211 may be different than a distance between cathode 220 and bottom surface 211. Each electrode may extend around an interior circumference of the microwell. Although the reaction site 201 shows a cathode 220 above an anode 230, each microwell may be configured such that the anode 230 may be above the cathode 220. Each microwell may be configured such that when the internal volume of the microwell may be occupied by electrochemically reactive solution 300, both the cathode 220 and the anode 230 are in contact with electrochemically reactive solution 300.

When both the cathode 220 and the anode 230 are in contact with electrochemically reactive solution 300 and a voltage is applied across cathode 220 and anode 230, a redox reaction may be initiated within electrochemically reactive solution 300. During the redox reaction, electrons may be transferred from the cathode 220 to the electrochemically reactive solution 300 (e.g., a reduction reactant within the solution) while electrons are transferred from the electrochemically reactive solution 300 (e.g., an oxidation reactant within the solution) to anode 230. This transfer of electrons may result in the formation of a circuit between cathode 220 and anode 230 that provides an observable faradaic current.

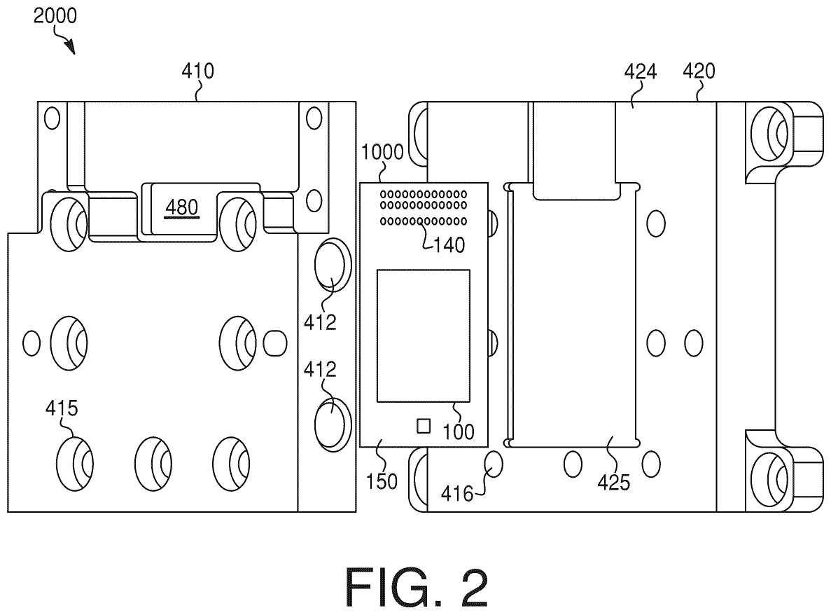

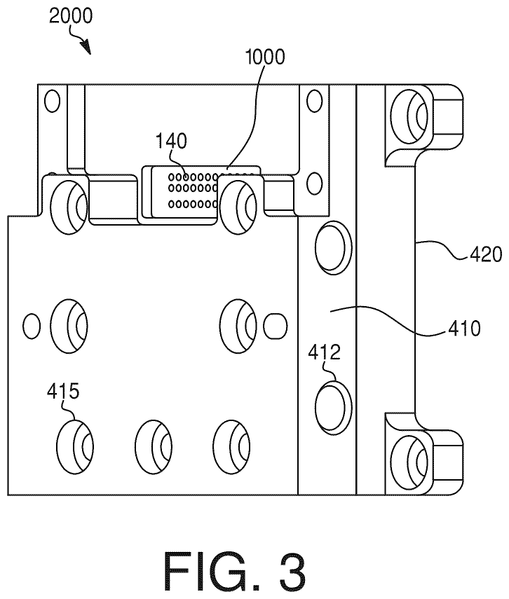

Referring to FIGS. 2 and 3, electrochemical chip 1000 may be a component of a flow cell assembly 2000. For example, the flow cell assembly 2000 may include an electrochemical chip 1000, a flow cell top 410, and a flow cell bottom 420. FIG. 2 shows an exploded view of a flow cell assembly 2000 including an electrochemical chip 1000, a flow cell top 410, and a flow cell bottom 420. FIG. 3 shows an assembled flow cell assembly 2000, where the flow cell top 410 forms a fluidic seal with flow cell bottom 420. As used herein, the terms “top” and “bottom” are used to distinguish between components of exemplary flow cell assemblies 2000, and do not necessarily imply an orientation of components in flow cell assembly 2000. A flow cell assembly 2000 may be assembled such that a flow cell bottom 420 may be above a flow cell top 410, flow cell bottom 420 may be lateral to flow cell top 410, or any other configuration where flow cell top 410 and flow cell bottom 420 form a fluidic seal.

Flow cell top 410 may include one or more fluid ports 412. In some embodiments, flow cell top 410 may include at least four fluid ports 412. Fluid ports 412 may be configured to interface with a fluid delivery system. Fluid ports 412 may configured to pass fluid into and from flow cell assembly 2000. For example, fluid ports 412 may be configured to allow fluid to pass from an exterior of flow cell assembly 2000 to an interior of flow cell assembly 2000 (e.g., to electrochemical chip 1000 within flow cell assembly 2000). In addition or alternatively, fluid ports 412 may be configured to allow fluid to pass from the interior of flow cell assembly 2000 to the exterior of flow cell assembly 2000. For example, fluid ports 412 may allow for a bidirectional flow of fluid (e.g., diluent and/or electrochemically reactive solution 300) into and from electrochemical chip 1000 within flow cell assembly 2000.

Flow cell top 410 may include one or more fastener ports 415. Each fastener port 415 may be configured to receive a fastener (e.g., a screw, a bolt, etc.). The fastener port 415 may allow for the fastener to pass through flow cell top 410 and into a fastener receiver 416 of flow cell bottom 420. In some embodiments, the fastener ports 415 and fastener receivers 416 of the flow cell assembly 2000 are configured such that the electrochemical chip 1000 may be surrounded on all sides by fasteners.

As described herein, electrochemical chip 1000 may include an electrical connection 140. Electrical connection 140 may facilitate the transfer of electric signal from a current source (e.g., a current source external to electrochemical chip 1000) to one or more electrodes (e.g., cathodes 220 and/or anodes 230) of the electrochemical chip 1000. Electrical connection 140 may allow for a computing device to connect with, transmit to, and/or receive signals from electrochemical chip 1000. Flow cell top 410 may include a connection aperture 480 configured to allow access to electrical connection 140 from the exterior of flow cell assembly 2000. For example, referring to FIG. 3, when flow cell assembly 2000 may be in an assembled state such that a fluidic seal may be formed between flow cell top 410 and flow cell bottom 420, electrical connection 140 may be accessible through connection aperture 480.

Referring again to FIG. 2, flow cell bottom 420 may include a bottom interface surface 424. When the flow cell assembly 2000 is assembled and a fluidic seal is formed between flow cell top 410 and flow cell bottom 420, bottom surface 424 may be in contact with flow cell top 410. Flow cell bottom 420 may include a recess 425. Recess 425 may be configured to receive electrochemical chip 1000. For example, recess 425 may be approximately the same size and dimensions, or alternatively, slightly bigger than the dimensions of electrochemical chip 1000, such that electrochemical chip 1000 can be positioned between flow cell top 410 and flow cell bottom 420 while there can be a fluidic seal between flow cell top 410 and flow cell bottom 420. In some embodiments, recess 425 may be substantially planar. Recess 425 may be substantially square, rectangular, or circular.

Flow cell bottom 420 may include one or more fastener receivers 416. Fastener receivers 416 may be configured to receive fasteners that have passed through fastener ports 415 of flow cell top 410. For example, flow cell assembly 2000 may be configured such that fastener ports 415 of flow cell top 410 align with fastener receivers of flow cell bottom 420. As described herein, tightening fasteners within the fastener ports 415 and fastener receivers 416 may decrease a distance between flow cell top 410 and flow cell bottom 420. In addition or alternatively, tightening fasteners within the fastener ports 415 and fastener receivers 416 may create a fluidic seal between flow cell top 410 and flow cell bottom 420.

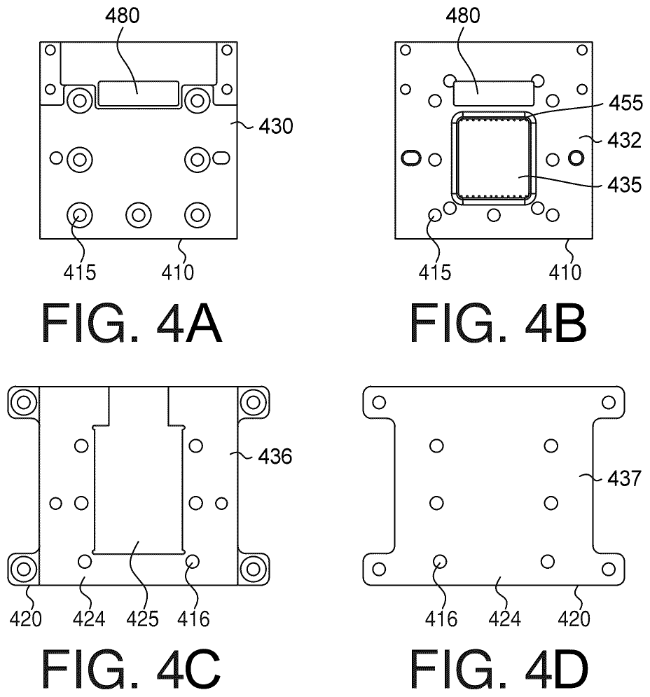

FIG. 4A include a front view of flow cell top 410, FIG. 4B includes a rear view of flow cell top 410, FIG. 4C includes a front view of flow cell bottom 420, and FIG. 4D includes a rear view of flow cell bottom 420. Referring to FIGS. 4A and 4B, flow cell top 410 may include a front surface 430 and a rear surface 432. Fastener ports 415 of flow cell top 410 may extend from front surface 430 to rear surface 432. Flow cell top 410 may include a top recess 435. Distributors 455, described herein, may be disposed in top recess 435. In addition or alternatively, distributors 455 may be in fluid communication with top recess. When flow cell assembly 2000 is assembled, top recess 435 may align with a portion of recess 425 of flow cell bottom 420.

Referring to FIGS. 4C and 4D, flow cell bottom 420 may include a front surface 436 and a rear surface 437. Fastener receivers 416 of flow cell bottom 420 may extend from front surface 436 to rear surface 437. During assembly of flow cell 2000, rear surface 432 of flow cell top 410 may be brought into contact with front surface 436 of flow cell bottom 420, such that fastener receivers 416 are aligned with fastener ports 415.

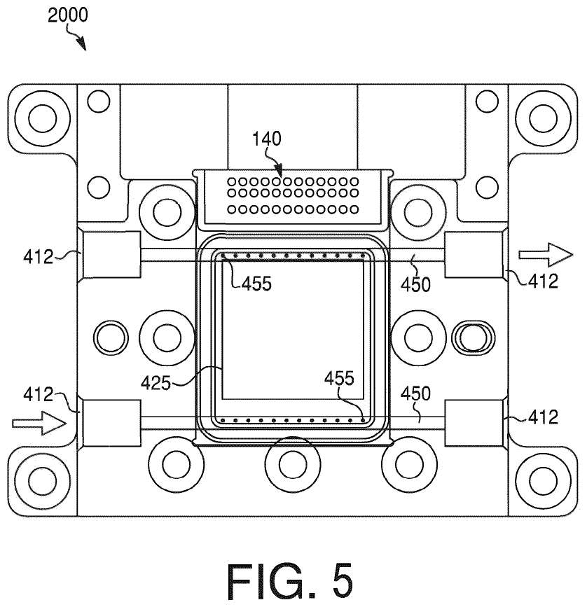

Referring to FIG. 5, each of the one or more fluid ports 412 may be connected to a manifold 450. Each manifold 450 may extend a length from a first fluid port 412 on a first surface of flow cell assembly 2000 to a second fluid port 412 on a second surface of flow cell assembly 2000. Manifolds 450 may be entirely within flow cell top 410. In some embodiments, manifolds 450 are formed when a fluidic seal is created between flow cell top 410 and flow cell bottom 420. Manifold 450 may connect fluid ports 412 from a first surface of flow cell assembly 2000 to a second surface of flow cell assembly 2000, where the second surface may be opposite the first surface. Manifold 450 may include one or more distributors 455 along a length of manifold 450. Distributors 455 may allow for fluid to flow from manifold 450 to recess 425. In addition or alternatively, distributors 455 may allow for fluid to flow from recess 425 to manifold 450.

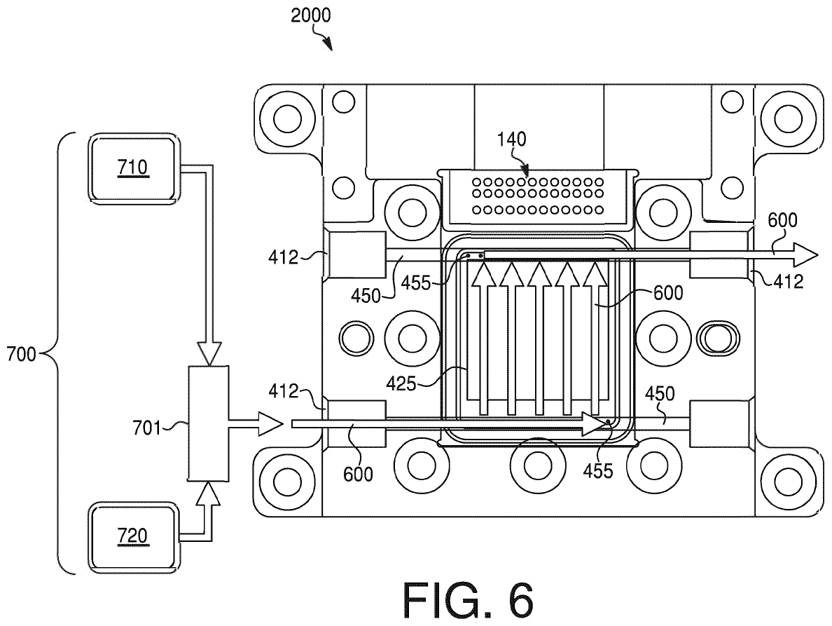

Referring to FIG. 6, an exemplary flow of fluid through flow cell assembly 2000 is shown by arrows 600. For example, fluid (e.g., diluent or an electrochemically reactive solution 300) may flow from a liquid delivery system 700, through a first fluid port 412, through a first manifold 450, and through distributors 455 to a cavity formed within recess 425 and/or top recess 435. Fluid entering recess 425 and/or top recess 435 may be distributed along an electrochemical chip 1000 within the cavity formed within recess 425 and/or top recess 435 of flow cell assembly 2000. For example, the fluid may enter one or more reaction sites 201 along electrochemical chip 1000. Still referring to FIG. 6, fluid may flow from the cavity, through a distributor 455 of a second manifold 450 to the second manifold 450, and from second manifold 450 through a second fluid port 412. Fluid exiting flow cell assembly 2000 through a fluid port 412 may be passed to another system (e.g., another flow cell assembly 2000), collected, and/or disposed of as waste.

Liquid delivery system 700 may include a pressure-driven delivery mechanism 710 and/or a pump-driven delivery mechanism 720. Pump-driven delivery mechanism 720 may include a syringe pump. Liquid delivery system 700 may include a valve 701 (e.g., a manual valve). Pressure-driven delivery mechanism 710 and pump-driven delivery mechanism 720 may both be fluidically connected to valve 701. In addition or alternatively, valve 701 may be fluidically connected to a fluid port 412. Valve 701 may be actuated to allow fluid from pressure-driven delivery mechanism 710 to enter fluid port 412. In addition or alternatively, valve 701 may be actuated to allow fluid from pump-driven delivery mechanism 720 to enter fluid port 412. Valve 701 may be configured such that fluid from only one of pressure-driven deliver mechanism 710 and pump-driven delivery mechanism 720 to enter fluid port 412 at one time. Fluid delivery system 700 may include multiple reservoirs of different fluids (e.g., electrochemically reactive solution 300, diluent, wash reagent). In some embodiments, pressure-driven delivery mechanism may be connected to a reservoir of one fluid (e.g., diluent) and pump-driven delivery mechanism may be connected to a reservoir of a different fluid (e.g., electrochemically reactive solution 300).

In some embodiments, the liquid delivery system 700 may deliver liquid to the flow cell cavity in volume increments. Fill volume increment may be 0.01 μL to 40 μL, such as 0.01 μL, 0.1 μL, 0.2 μL, 0.5 μL, 1 μL, 2 μL, 5 μL, 10 μL, 20 μL, 30 μL, or 40 μL. In some embodiments, the fill volume increment may be 0.5 μL. In some embodiments, the fill volume increment may be 1 μL. In some embodiments, the fill volume increment is 10 μL. In some embodiments, the fill volume increment may be 20 μL.

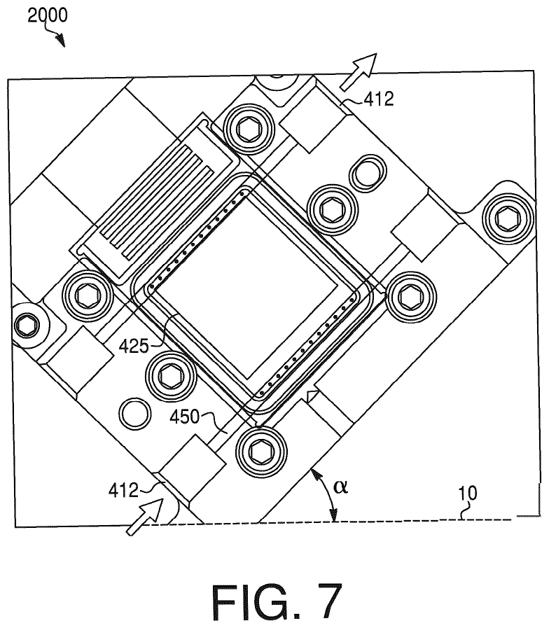

As described herein, flow cell assembly 2000 positioned in various orientations, such as vertical, horizontal, or tilted. In some embodiments, the flow cell assembly may be partially or fully vertical during operation. In some embodiments, “at least partially vertical” or “tilted” refers to an orientation in which a planar surface of the electrochemical chip is at an angle α which is greater than about 0° relative to a gravitational plane. Referring to FIG. 7, angle α may be defined as the angle formed between an edge flow cell assembly 2000 and the gravitational plane 10. In some embodiments, angle α is less than or equal to about 90°, less than or equal to about 80°, less than or equal to about 70°, less than or equal to about 60°, less than or equal to about 50°, less than or equal to about 40°, less than or equal to about 30°, less than or equal to about 20°, less than or equal to about 10°, or less than or equal to about 5°. In some embodiments, angle α is about 90°, about 85°, about 80°, about 75°, about 70°, about 65°, about 60°, about 55°, about 50°, about 45°, about 40°, about 35°, about 30°, about 25°, about 20°, about 15°, about 10°, or about 5°.

In some embodiments, the flow cell assembly 2000 may be placed in a vertical or tilted orientation using a stand or base. The flow cell assembly 2000 may include or may be connectable to a base station or platform to which, in some instances, one or more fluid dispensing stations (e.g., a liquid delivery system 700) can be stably associated (e.g., by mounting). In some embodiments, a mount may be used to place the flow cell on a stand or base, such that the flow cell assembly can be oriented at one or more angles.

Provided herein are systems for electrochemical sensing during oligonucleotide synthesis. In some embodiments, the system includes a liquid delivery system 700 as described herein, a flow cell assembly 2000 including an electrochemical chip 1000 as described herein, electrical components, and a computing device (e.g., CPU/PC).

Electrical components may include, for example, electrical devices electrically interfaced with the electrochemical chips 1000 and configured to deliver voltage to and measure current from the reaction sites 201 of the electrochemical chips 1000.

Digital inputs from a computing device may be delivered to Digital to Analog Converters (“DACs”) which convert the digital inputs to voltage outputs applied to the electrochemical chips. DACs may apply voltage to a plurality of reaction sites 201 in a flow cell assembly 2000 as described herein, in various configurations. For example, a flow cell assembly 2000 may include an electrochemical chip 1000 including a plurality of reaction sites 201 arranged in a plurality of Digital to Analog Converter (“DAC”) groups. Each row of reaction sites may fall within one DAC group, or may fall within more than one DAC group. A DAC may apply a voltage to each DAC group based on a digital input from a computing device. In some embodiments, the electrochemical chip may include about 10 DAC groups to about 500 DAC groups. In some embodiments, the electrochemical chip may include about 10 DAC groups, about 20 DAC groups, about 30 DAC groups, about 40 DAC groups, about 50 DAC groups, about 60 DAC groups, about 70 DAC groups, about 80 DAC groups, about 90 DAC groups, about 100 DAC groups, about 150 DAC groups, about 200 DAC groups, about 250 DAC groups, about 300 DAC groups, about 350 DAC groups, about 400 DAC groups, about 450 DAC groups, or about 500 DAC groups.

Current may be measured from the reaction sites 201 of the electrochemical chips 1000 described herein and converted to digital outputs through the use of Analog to Digital Converters (“ADCs”). In some embodiments, a single ADC may measure (sample) current at a single electrode (e.g., cathode 220 or anode 230) or at multiple electrodes (e.g., cathodes 220 and anodes 230). In some embodiments, a pair of ADCs may measure (sample) current at a complementary (paired) cathode 220 and anode 230, or at multiple cathodes and multiple anodes. In some embodiments, one or more ADCs may measure (sample) current throughout the active area 100 of the electrochemical chip 1000, as described herein. In some embodiments, a single ADC may be multiplexed with multiple anodes 230 from a plurality of reaction sites 201 arranged within a single row. In some embodiments, a single ADC may be multiplexed with multiple cathodes 220 from a plurality of reaction sites 201 arranged within a single row. In some embodiments, an ADC pair includes an ADC measuring (sampling) current from one or more cathodes 220 and an ADC measuring (sample) from one or more anodes 230. In some embodiments, the electrochemical chip 1000 may include about 10 ADC pairs to about 500 ADC pairs. In some embodiments, the electrochemical chip 1000 may include about 10 ADC pairs, about 20 ADC pairs, about 30 ADC pairs, about 40 ADC pairs, about 50 ADC pairs, about 60 ADC pairs, about 70 ADC pairs, about 80 ADC pairs, about 90 ADC pairs, about 100 ADC pairs, about 150 ADC pairs, about 200 ADC pairs, about 250 ADC pairs, about 300 ADC pairs, about 350 ADC pairs, about 400 ADC pairs, about 450 ADC pairs, or about 500 ADC pairs.

As described herein, the electrochemical chip 1000 may include an electrical interface. The electrical interface may receive communications from a computing device, such as a CPU/PC. For example, the electrical interface may be a serial peripheral interface (SPI) integrated with a field programmable gate array (FPGA) interface board. Digital information may be transmitted via the SPI from the computing device to the FPGA interface board, which may be integrated with further electrical components which receive or provide electrical input to the electrochemical chip based on the transmitted information. For example, the FPGA interface board may be integrated with a Digital to Analog Converter (DAC) which converts the digital information to a voltage output applied to the electrochemical chip. As another example, the FGPA interface board may be integrated with an Analog to Digital Converter (ADC) which converts the current input from the electrochemical chip to digital information.

In some embodiments, the computing device may be located on an external device and configured to receive one or more signals from the electrochemical chip 1000. The computing device can be any suitable processing device(s) configured to run and/or execute a set of instructions or code. For example, the computing device can be and/or can include one or more data computing devices, image computing devices, graphics processing units (GPU), physics processing units, digital signal computing devices (DSP), analog signal computing devices, mixed-signal computing devices, machine learning computing devices, deep learning computing devices, finite state machines (FSM), compression computing devices (e.g., for data compression to reduce data rate and/or memory requirements), encryption computing devices (e.g., for secure wireless data and/or power transfer), and/or the like. The computing devices can be, for example, a general-purpose computing device, central processing unit (CPU), edge computing and/or edge AI computing device, edge machine learning computing device, and/or the like.

Digital information may be passed from the computing device to the electrical interface through wired connections. In some embodiments, the wired communications may include a communication bus, such as a serial bus, Ethernet bus, and the like. For example, digital information may be passed from the computing device to a universal serial bus (USB), which then passes the digital information to the electrical interface. In some aspects, the digital information may be passed in batches. For example, the digital information may be passed in the form of SPI messages from a computing device to a USB to an FPGA interface board. An SPI message may include a request to an ADC to sample (measure) current. An ADC sampling request may include setting a full-scale value according to an expected current magnitude. The expected current magnitude may be inputted by a user. An ADC sampling request may include selecting a plurality of reaction sites 201 from which current can be measured. In addition to or alternative to sampling request, a register bit may be flipped to trigger sampling, and/or a data register that operates with a data width of eight bits (e.g., an 8-bit data register) may be read to obtain a sampled (measured) value.

Sampled (measured) values may be transmitted to the computing device via the electrical interface, such as from an SPI of an FPGA interface board to a USB to the computing device. Once received by the computing device, a sampled value from the ADC may then be mapped to a current value and timestamped for later reference. The sampled value from the ADC may be mapped using a transformation, such as a linear transformation. The computing device may perform data processing as described herein, such as generating corrected, normalized area under the curve (AUC) values before writing the processed data to file. Alternatively, it is also contemplated that sampled values may be written to file before data processing. The timestamp may be used to correlate fill conditions at a certain reaction site with oligonucleotide synthesis at that reaction site at that time.

Methods of the present disclosure may include electrochemically sensing conditions in a flow cell assembly 2000, such as, for example, the flow cell assemblies described herein. Electrochemically sensing conditions may include determining a liquid level, a fill percentage, and/or a flow rate.

A method of electrochemically sensing conditions in a flow cell assembly 2000 may include assembling an electrochemical chip 1000 inside a flow cell assembly 2000. The method may include interfacing fluidic components and/or electric components with flow cell assembly 2000. For example, interfacing fluidic components may include connecting liquid delivery system 700 to flow cell assembly 2000 (e.g., via fluid port 412). Interfacing electric components may include connecting a computing device to the flow cell assembly 2000 via electrical connection 140. The connected computing device may manage and direct delivery of voltage pulses to electrochemical chip 1000. In addition or alternatively, the connecting computing device may manage measuring and/or processing of electrical signals from electrochemical chip 1000.

Methods of electrochemically sensing conditions in a flow cell may further include delivering electrochemically reactive solution to the flow cell. The electrochemically reactive solution may be delivered via liquid delivery system 700 (e.g., pump-driven delivery mechanism 720). Various mechanisms may be used to drive delivery of the electrochemically reactive solution. For example, the electrochemically reactive solution may be delivered using a pump-driven delivery mechanism, a pressure-driven delivery mechanism, or a gravity-driven delivery mechanism.

The electrochemically reactive solution may be delivered to the flow cell at varying flow rates. For example, the electrochemically reactive solution may be delivered at a flow rate of about 0.01 μL/s to about 50 μL/s, about 0.01 μL/s, about 0.02 μL/s, about 0.05 μL/s, about 0.1 μL/s, about 0.2 μL/s, about 0.5 μL/s, about 1 μL/s, about 2 μL/s, about 3 μL/s, about 4 μL/s, about 5 μL/s, about 6 μL/s, about 7 μL/s, about 8 μL/s, about 9 μL/s, about 10 μL/s, about 11 μL/s, about 12 μL/s, about 13 μL/s, about 14 μL/s, about 15 μL/s, about 20 μL/s, about 25 μL/s, about 30 μL/s, about 35 μL/s, about 40 μL/s, about 45 μL/s, or about 50 μL/s.

The electrochemically reactive solution may be delivered in varying total volumes. For example, the electrochemically reactive solution may be delivered to a flow cell in a total volume of about 1 μL to about 500 μL, about 1 μL, about 2 μL, about 5 μL, about 10 μL, about 20 μL, about 50 μL, about 100 μL, about 200 μL, or about 500 μL. The electrochemically reactive solution may be delivered in incremental volumes until reaching a total volume. For example, the electrochemically reactive solution may be delivered to the flow cell in incremental volumes of about 0.01 μL to about 20 μL, about 0.01 μL, about 0.02 μL, about 0.05 μL, about 0.1 μL, about 0.2 μL, about 0.5 μL, about 1 μL, about 2 μL, about 5 μL, about 10 μL, or about 20 μL.

In addition or alternatively, the method of electrochemically sensing conditions in a flow cell assembly 2000 may include performing a chip-health check to determine reaction sites 201 with defects. Reaction sites 201 with defects may be eliminated and/or not used in further operations involving the chip. Eliminating the reaction sites 201 may include disabling a region of the chip including the reaction sites 201 with defects. The chip-health check may include iteratively sampling current in a subsection of a dry chip, and identifying shorts. The method of electrochemically sensing conditions in a flow cell assembly 2000 may include delivering diluent to the flow cell and measuring zero-current condition for all reaction sites 201 to obtain a background value. The method may further include delivering an electrochemically reactive solution to the flow cell, and/or applying a custom voltage pulse. The custom voltage pulse may direct electrical energy to a plurality of reaction sites 201, and induce a chemical reaction at each of the plurality of reaction sites 201. The plurality of reaction sites 201 may be pre-determined (e.g., selected by a user). The method may include measuring one or more current values for each reaction site of the plurality of reaction sites 201. In addition or alternatively, current values may be measured for one or more groups, sets, or subsets of reaction sites of the plurality of reaction sites 201.

Methods of electrochemically sensing conditions in a flow cell may further include washing the plurality of reaction sites 201 with a diluent reagent. The diluent reagent may include an aqueous solution. The diluent reagent may include acetonitrile. Washing the plurality of reaction sites 201 with the diluent reagent may include applying wash reagent or diluent reagent to each reaction site. In addition or alternatively, washing the plurality of reaction sites 201 with the diluent reagent may include applying at least wash reagent or diluent reagent with electrochemically reactive solution within the chip. In addition or alternatively, washing the plurality of reaction sites 201 may include applying wash reagent or diluent reagent to the flow cell until the flow cell is filled with a full volume of wash reagent or diluent reagent; filling an outlet manifold of the flow cell to a full volume of wash reagent or diluent reagent; and vacating all wash reagent or diluent reagent from the flow cell and outlet manifold. These steps may be repeated multiple times, such as two, three, or four times.

Methods of electrochemically sensing conditions in a flow cell may further include drying the plurality of reaction sites 201. Drying the plurality of reaction sites 201 may include vacating all reagent from the flow cell and from an outlet manifold of the flow cell, and waiting a duration of time sufficient to allow for desiccation of all reaction sites and manifold surfaces. In addition or alternatively, drying the plurality of reaction sites 201 may include vacating all reagent from the flow cell and from an outlet manifold of the flow cell, applying gas to the outlet manifold and flow cell in a volume sufficient for desiccation of all reaction site and manifold surfaces. Drying the plurality of reaction sites 201 may be performed after washing the plurality of reaction sites 201, as described above

Downstream processing and data analysis may be used to determine fill conditions at any reaction site 201 during or after oligonucleotide synthesis using the flow cell assemblies 2000 described herein.

Zero-correcting may involve measurement and logging of current in one or more reaction sites 201 when a flow cell assembly 2000 contains no electrochemically reactive solution (“zero current condition,” e.g., fill with diluent reagent only), and subtracting that value from a current measurement during or after filling with electrochemically reactive solution. For example, a zero-corrected current for a group (e.g., row N) of reaction sites 201 (I_{row N, zero-corrected}) may be calculated according to Equation 1, where zero current condition for row N of reaction sites 201 (I_{row N, zero current}) may be subtracted from a measurement of the same row of reaction sites 201 after or during filling (I_{row N}).

$${I}_{row N , zero - corrected} = {I}_{row N} - {I}_{row N , zero current} \qquad Equation 1$$

Area under the curve (AUC) analysis may include plotting zero-corrected current values for one or more reaction sites 201 versus location of the one or more reaction sites 201, and summating said zero-corrected current values to generate an AUC value. For comparison across various flow cell assemblies and systems, each AUC value may be normalized to an origin point value generated from calculating an AUC value just prior to filling with electrochemically reactive solution. Normalized, zero-corrected AUC values may be plotted versus fill volume (Δ) from origin point.

A histogram plot may be generated based on measured current values (e.g., normalized, zero-corrected AUC values). For example, current values may be binned (e.g., 0.25 μA increments), and number of reaction sites 201 may for each bin may be plotted versus the current values of the bins. Histogram plots may be used to provide visual guidance to a user during and after use of the flow cell assemblies as described herein. For a given stage in a flow cell assembly operation, the shape of the generated histogram plot may be qualitatively and quantitatively analyzed to determine whether a current or previous stage of the flow cell assembly operation is proceeding within acceptable parameters. For example, the shape of the histogram may be compared to one or more reference histograms or reference histogram profiles. In one or more embodiments, the shape of generated histogram may be visually compared to a Gaussian distribution. In addition or alternatively, quantitative comparisons may be made between the generated histogram and one or more reference histograms or reference histogram profiles.

Fill percentage may be calculated by comparing zero-corrected current values measured as described herein to a zero-corrected current value from a fully-filled state. For example, a fill percentage for a group (e.g., row N) of reaction sites 201 after filling with an electrochemically reactive solution may be calculated according to Equation 2, where I_{row N} is the measured current of the group of reaction sites 201, I_{row N, fully filled} is the current of the group of reaction sites 201 in a full-filled state, and I_{row N, zero current} is the current of the group of reaction sites in a zero current state.

$$Fill Percentage = \frac{{I}_{row N} - {I}_{row N , zero current}}{{I}_{row N , full filled} - {I}_{row N , zero current}} \times 100 \qquad Equation 2$$

A fully-filled state may be defined as a condition when the entire electrochemical chip 1000 can be covered with the same maximum concentration of reactants (C₀). When not in a fully-filled state, a reaction site could generate faradaic currents lower than the current associated with the full-filled state. This lower faradaic current may be directly related to the concentration (C) of the reactants in contact with the electrodes in the reaction sites 201. For example, concentration gradients may be generated by dispersion during a fill. Accordingly, the zero-corrected currents for a row may be normalized with the zero-corrected fully-filled condition (I_{fully filled}), expected to offer maximum current condition for the experiment.

Fill level of electrochemically reactive solution in a flow cell assembly 2000 as described herein may be calculated by performing a four-parameter symmetric sigmoidal fit on the plots of the normalized, zero-corrected current values as described above. The four parameter sigmoidal fit may be performed based on Equation 3, where x is a number of a row of reaction sites 201 at which a fill percentage y may be reached, relative to a maximum value reached in a fully-filled state.

$$y ( x ) = d + \frac{( a - d )}{1 + {( \frac{x}{c} )}^{b}} \qquad Equation 3$$

For example, x may be calculated for a y value of 50% to determine an exact row number where the percent fill is half the maximum value reached in a fully-filled state.

Volume fill of electrochemically reactive solution may be calculated in view of mechanical dimensions of the active area 100 as described herein, using the following equation:

$$Δvolume = \frac{Δrow \times ( width of active area ) \times ( gap of active area )}{1000 μ L} \qquad Equation 4$$

Actual volume fill values may be compared to intended volume fill values by generating plots of volume of incremental fill (Δ volume) for each fill versus incremental fill from origin. Incremental fill (Δ volume) in μL is calculated using Equation 4, which divides the product of change in number of current-generating rows (Δ row), width of active area of the electrochemical chip, and gaps within the active area of the electrochemical chip by 1000 μL.

Provided herein are additional applications of the electrochemical chips 1000 described above, including applications relating to micro-scale physics and detection of chemical phenomena, process development and design, and more. As described further below, various embodiments of the electrochemical chips 1000 may be used for these additional applications. However, all the electrochemical chips 1000 can have the presence of a redox molecule or ionic species in solution to perform the electrochemistry on the chip (e.g., microelectrode array).

In some embodiments, the electrochemical chip 1000 may be configured to detect non-faradaic capacitive charging current using an electrolyte (e.g., ionic species) in solution, instead of a redox reaction.

In some embodiments, the electrochemical chip 1000 may be exposed to a reagent cavity including a solid or semi-solid medium, rather than having a flow cell. In some embodiments, the medium includes a gel, a cellulose, a matrix, a lateral flow assay, and the like.

In some embodiments, parameters of the electrochemical chip 1000 that can be modified include chemical and reagent parameters (e.g., redox molecule, electrolyte, solvent, reagent concentrations, and electrons involved in the reaction); physical parameters (e.g., electrode material, number of electrodes, pitch, size, configuration, planarity, and electrode quality); mechanical hardware parameters (e.g., liquid delivery systems, flow cells, dimensions, fluidic architecture, manifolds, flow rates, pressure, materials, electronics, drivers, and software); and electrochemical parameters (e.g., voltage pulse duration, amplitude, configuration, and number of activated electrodes).

### EXAMPLES

### Example 1: Electrochemical Liquid-Level Sensing (0.5 μL, 1 μL, 10 μL Fill Increments)

### Experimental Setup

The primary components of the experimental setup include a liquid delivery system, a flow cell containing an exemplary electrochemical chip as described herein, electrical components, and a CPU/PC. The liquid delivery system utilized a pressure-driven delivery mechanism to introduce diluent to the flow cell cavity and to perform washing and drying processes. A washing protocol was performed with acetonitrile (ACN) as a wash reagent, and involved a liquid-liquid displacement of the prior reagent with the wash reagent. Drying was performed and parameters such as duration and number of washes were optimized by flow visualization techniques. The liquid delivery system also utilized a syringe pump as a pump-driven delivery mechanism for controlled delivery of an electrochemical reactive solution. The liquid delivery system also utilized a manual valve upstream of the flow cell to switch between the pressure-driven delivery mechanism and the pump-driven delivery mechanism.

The electrochemical chip was assembled into the flow cell between the top and bottom components to form a fluidic cavity over the oligonucleotide-synthesis substrate where reagents could be introduced, and electrochemistry could be performed. For the purposes of this experiment, the flow cell was held vertically, such that orientation of the substrate (and cavity) was perpendicular to the platform on which the flow cell was fixed. Fluidic connections were attached to the flow cell and electrical connections were interfaced with the electrochemical chip.

### Experimental Workflow

A chip-health check was performed to determine defective reaction sites on the electrochemical chip for disabling during operation. Then, acetonitrile was delivered into the flow cell using the pressure-driven delivery system. A voltage pulse was applied to each of the 16000 rows with the parameters described above to obtain a zero-current reading, which was later subtracted from all current readings as background subtraction.

Next, the manual valve was switched to the syringe pump to deliver 200 μL of electrochemically reactive solution to the flow cell at a flowrate of 20 μL/sec. This fill amount was used as an origin fill condition for determining level changes. A voltage pulse was then applied, and current measurements were recorded, logged, and processed for all 16000 rows.

Next, 0.5 μL of electrochemically reactive solution was delivered to the flow cell at a flowrate of 1 μL/sec. A voltage pulse was applied, and current measurements were recorded, logged, and processed for all 16000 rows. The steps of adding 0.5 μL of electrochemically reactive solution, applying a voltage pulse, and recording current measurements was repeated for a total of 30 times.

Next, the entire flow cell was filled to a maximum volume by delivering an excess volume of about 120 μL delivered at a flow rate of 20 μL/sec. A voltage pulse was applied and current measurements recorded to obtain a filled flow cell state condition current reading.

Next, the manual valve was switched to the pressure-driven system to deliver acetonitrile to wash the flow cell twice. The flow cell was then dried.

All the above steps described with respect to 0.5 μL (30 increments) were also performed with other volumetric fills 1 μL (30 increments) and 10 μL (10 increments).

Downstream processing and data analysis was performed to demonstrate the capability of the electrochemical chip to detect fill amount and liquid level inside the flow cell. For every volumetric fill condition, the zero current condition was subtracted from the row current (I_{row}) to obtain the zero-corrected current, according to Equation 1.

The summation of currents from all the rows was calculated for that fill condition as area under the curve (AUC) for the plot of zero-current current versus row number. For every volumetric fill condition, the origin point was different due to mechanical/system variance. For the purposes of comparison, AUC values for the various fill conditions were normalized to origin point value. Accordingly, data was reported in plots of normalized, zero-corrected AUC current values versus increment (Δ) fill from origin.

Current values were binned into 0.25 μA increments to generate histogram plots reporting number of rows versus current values to produce Gaussian profiles. These were primarily used for visual guidance on changes in the shape of the curve with incremental fills.

For every volumetric fill condition, the zero-corrected current value for each row was normalized to the current value in the fully filled state and converted to a percentage, according to Equation 2.

A four-parameter symmetric sigmoidal fit was performed on the plots of the normalized, zero-corrected current versus row number to obtain four parameters a, b, c, and d for each fill condition based on Equation 3.

For the sigmoidal fit, x values corresponding to row numbers were calculated foray value of 50% to determine the exact row number where the percent fill is half the maximum value reached in a fully filled state. For every volumetric fill condition, differences in x values were used to back-calculate volume fill in view of the mechanical dimensions of the active area according to Equation 4.

Plots were generated for increment volume calculated for each fill versus increment fill from origin to determine if actual back-calculated volumes matched intended volume additions.

### Results

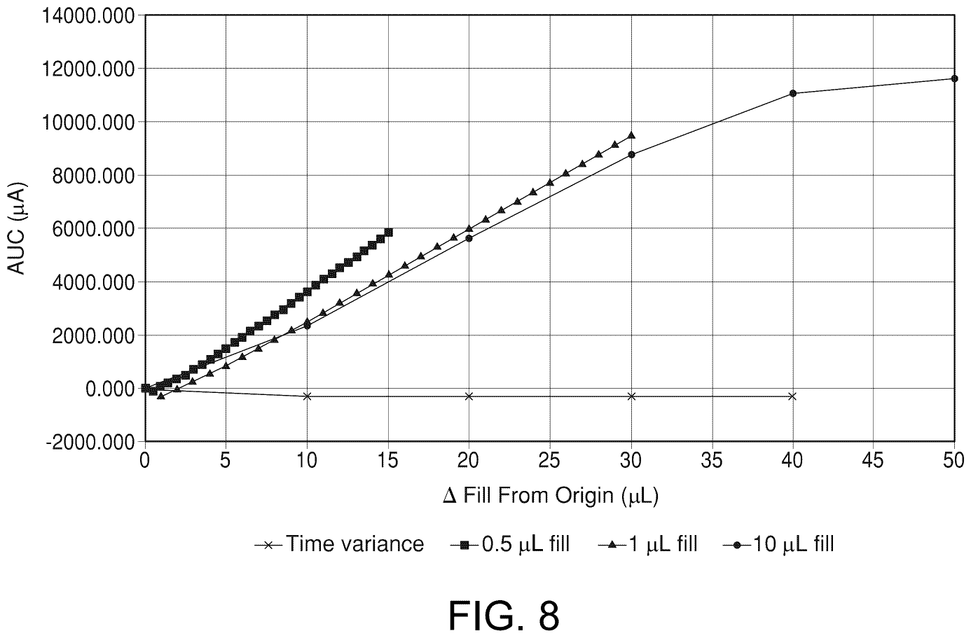

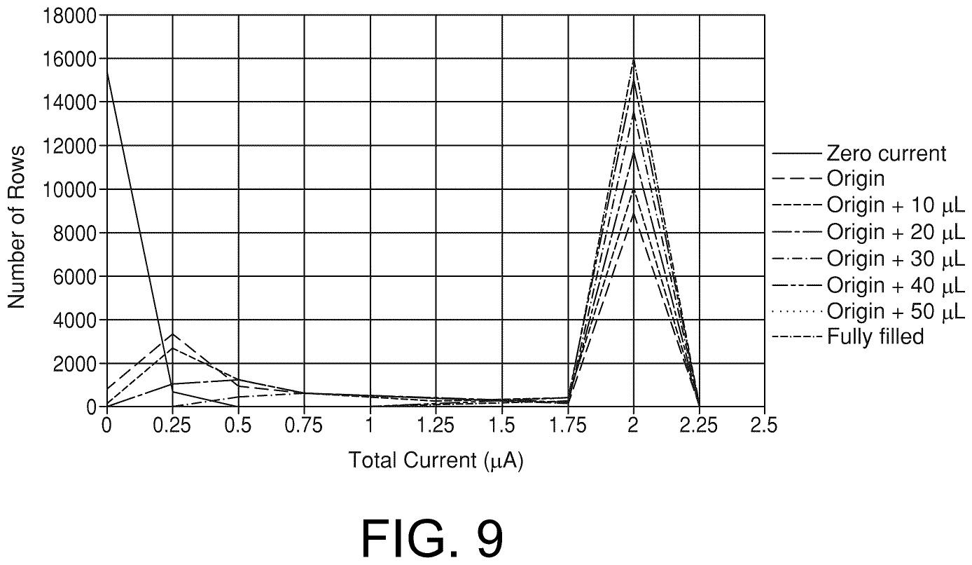

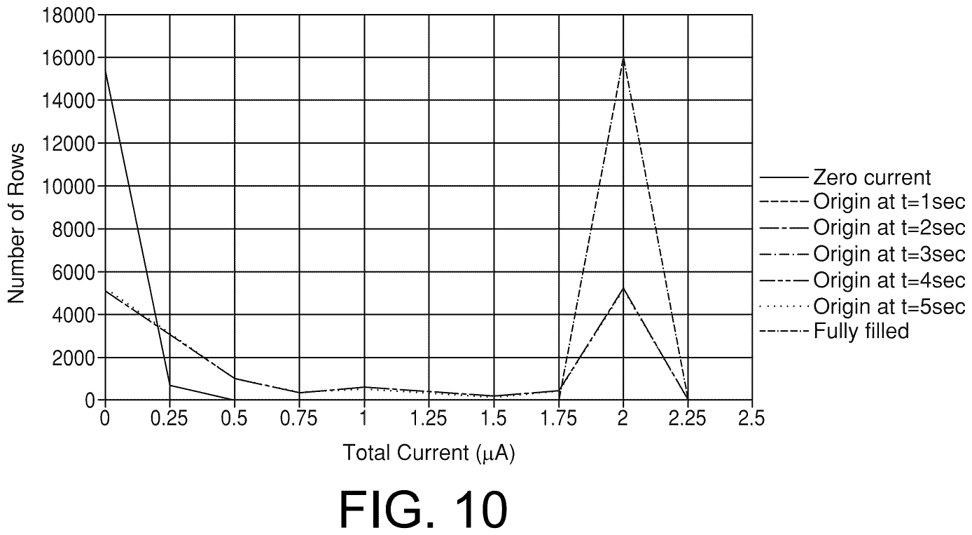

AUC analysis was performed on a first exemplary electrochemical chip (i.e., Chip A) for volumetric fills of 0.5 μL, 1 μL, and 10 μL. As shown in FIG. 8, incremental fills as a function of fill from origin were detected and measured, and variation in current as a function of time was negligible when compared to variations as a function of fill volume. Histogram analysis was performed for all fill increments and time variance experiments to visually observe the change in Gaussian profiles with volumetric fills. For example, as shown in FIG. 9, as the flow cell was increasingly filled with the electrochemically reactive solution in 10 μL increments, the number of rows generating maximum faradaic current increased accordingly. A time variance experiment (FIG. 10) demonstrates the effect of time on the shapes of the plots was negligible, providing confidence of successful detection of volumetric fill increments in the flow cell.

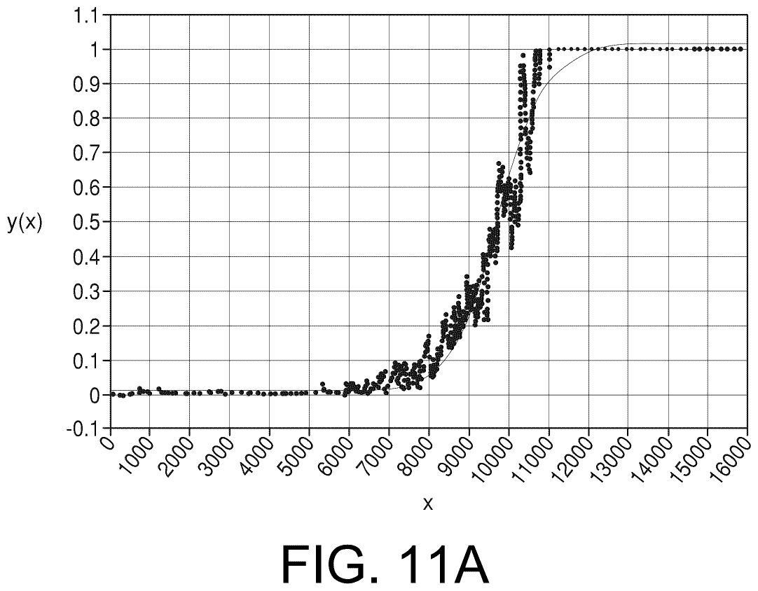

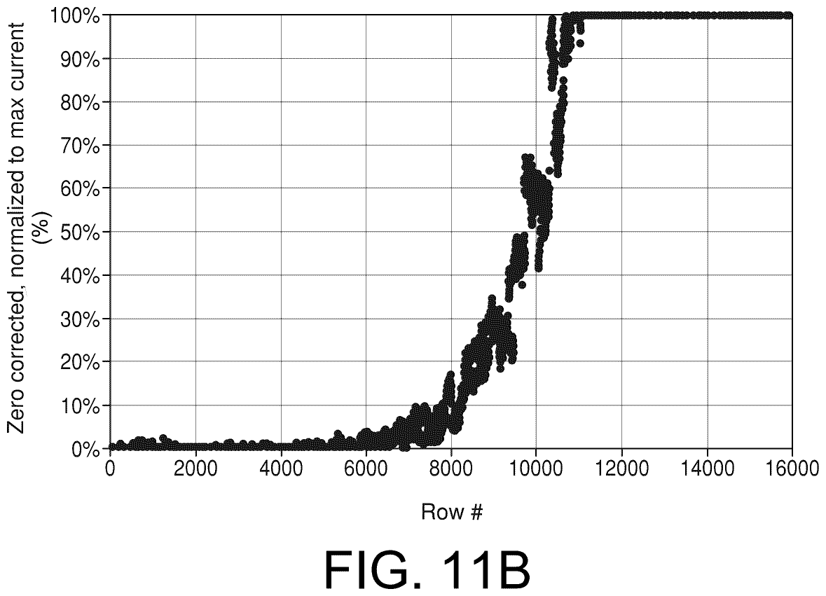

Further analysis was performed to back-calculate incremental fill volumes from the collected data in view of the physical dimensions of the flow cell cavity and 1 μm-spacing between reactions rows on the electrochemical chip. As described above, background subtraction was performed with only diluent to obtain the zero-corrected current (I_{zero current}), and zero-corrected currents for a row were normalized with the zero-corrected fully-filled condition (I_{fully filled}), expected to offer maximum current condition for the experiment. As shown in FIG. 11A, normalized and zero-corrected currents are plotted against the row number for every incremental fill. Analysis methods were used to perform a four-parameter symmetric sigmoidal curve-fit (FIG. 11B) on the data to obtain constant values (a, b, c, d) and the row number for reaching half of the maximum value (X_{50%}) was calculated.

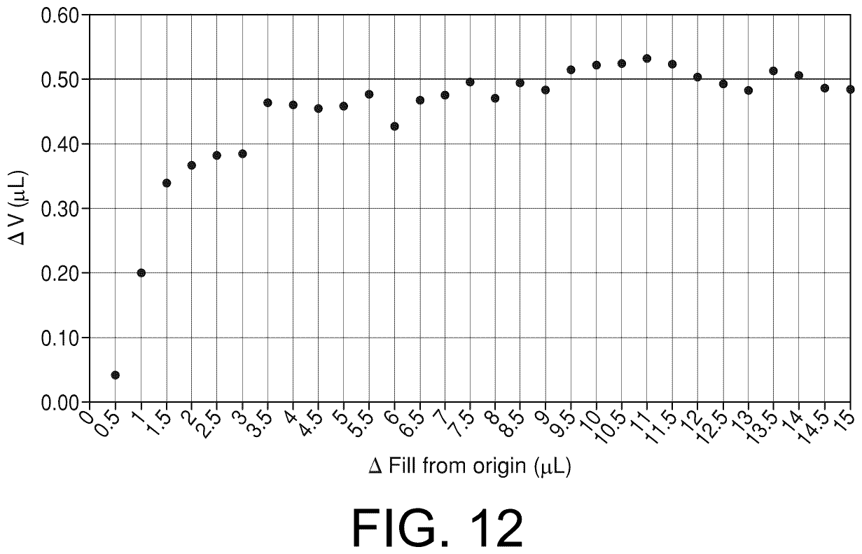

To determine the distance, in microns, moved by the fluid front for a fill, the difference in X_{50%} values for every incremental fill was multiplied by the width and gap height of the flow cell to obtain back-calculated volume increments. As shown in FIG. 12, back-calculated volume increments were generated for every intended 0.5 μL fill increment from origin. On average, back calculated volumes were about 0.5 μL, demonstrating the capability of the technology to detect and determine fill quantities based on electrochemical output.

This experiment demonstrates the versatility of the oligonucleotide-synthesis electrochemical chips described herein for detecting the exact liquid level inside a flow cell cavity, and for quantitatively measuring fill profiles for different fill volume increments. Further, this experiment successfully demonstrates detection of incremental fills and reagent levels inside a flow cell cavity over an oligonucleotide-synthesis substrate. In addition, this experiment observed the current profile of the chip as having a linear response to fill volume for electrochemical output post-data processing, which can be used for back-calculating exact fill increments inside the flow cell cavity from a recorded current reading.

### Example 2: Intra-Chip Repeatability and Inter-Chip Repeatedly

The experiment described in Experiment 1 was repeated a second time (n=2) for Chip A to measure intra-chip variance. The same experiments were also performed twice (n=2) for on a second exemplary electrochemical chip (i.e., Chip B) to measure inter-chip variance. Chip A and Chip B did not differ in orientation, dimension, or any other parameter. For each chip, an experiment was performed to determine the impact of time on the current changes, to ensure the differences seen for various fills were due to electrochemical phenomena and not due to time. Five current readings were taken at 1 second intervals for the origin fill condition (described above) to measure this variance.

### Results

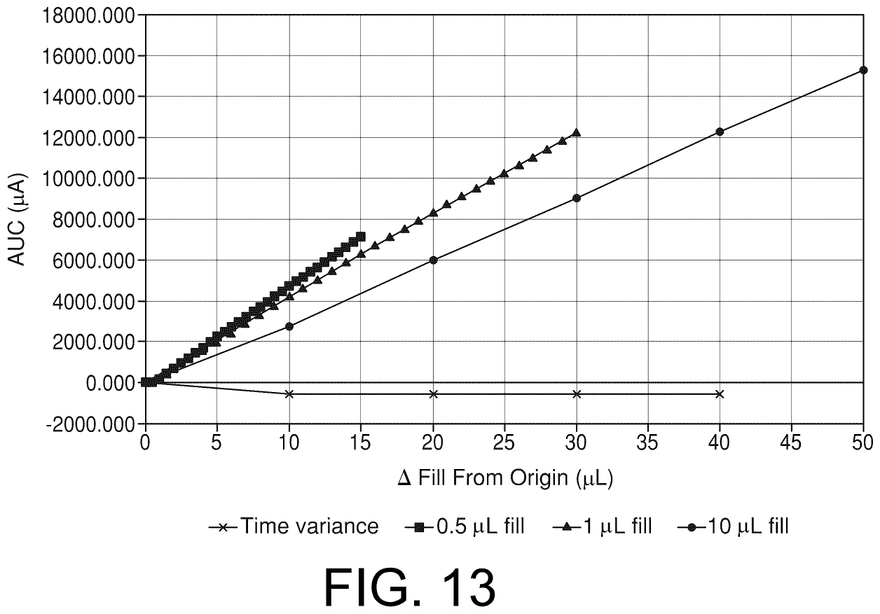

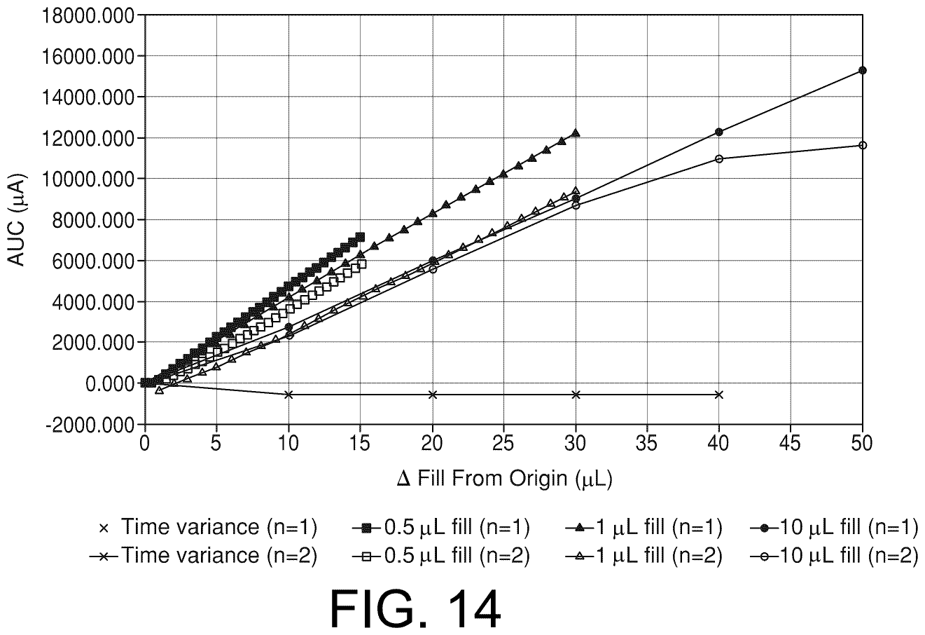

AUC analysis as described in Example 1 was performed for a second run on Chip A (FIG. 13) and compared to the first run (FIG. 8). Linear fill characteristics were observed across all run conditions and fill increment conditions. Differences in slope and intercepts were observed between conditions. As shown in FIG. 14, average current variance between runs was greatest for the 10 μL fill condition (11%) as compared to the variance in the 0.5 μL fill condition (3%) and the 1 μL fill condition (2%).

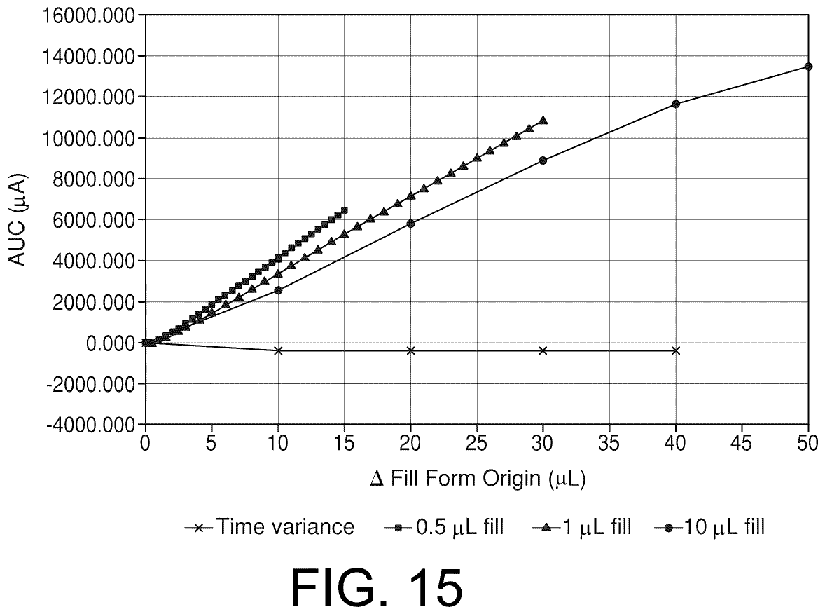

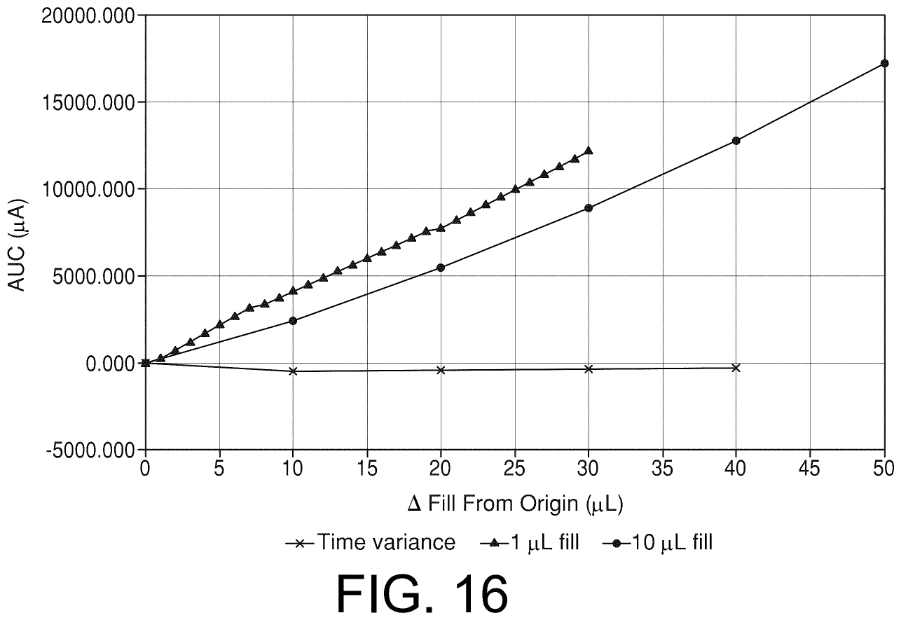

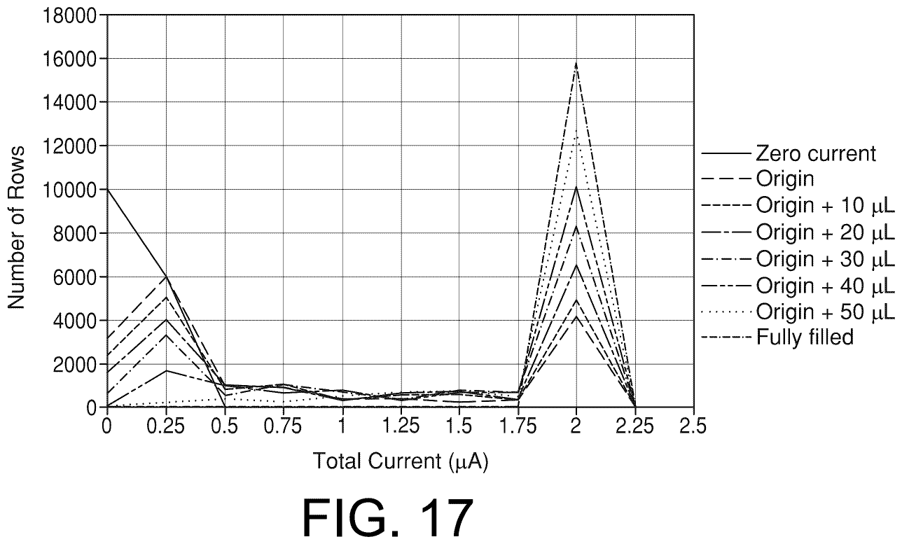

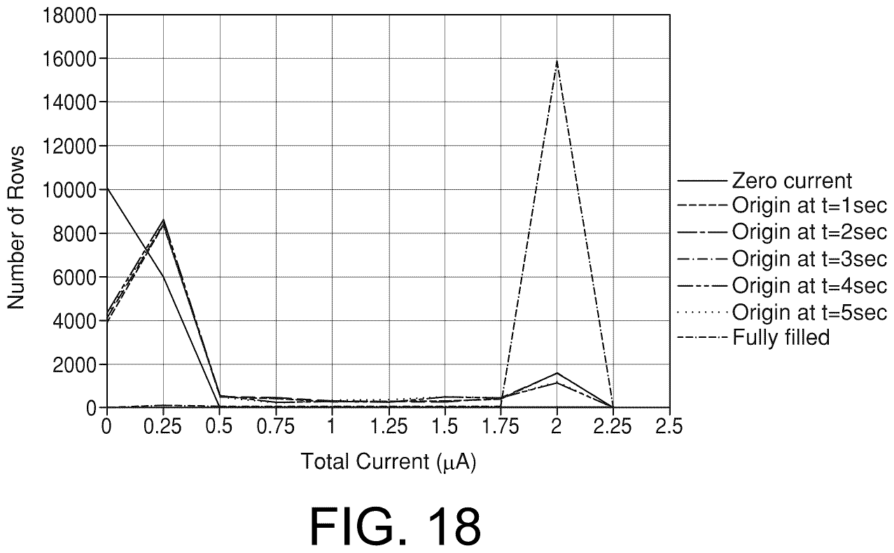

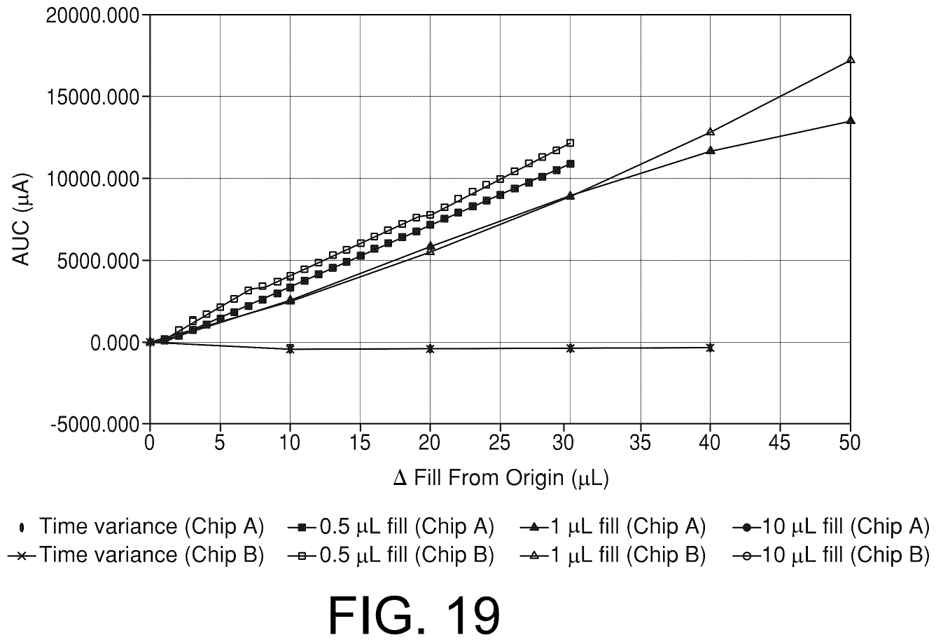

AUC analysis (FIG. 15) for various fill conditions, and histogram analysis (FIG. 16) as described in Example 1 were performed for two runs on Chip B. Histogram analysis for the 10 μL fill condition on Chip B demonstrated similar outcomes as Chip A. As the flow cell increasingly filled with electrochemically reactive solution in 10 μL increments, the number of rows generating the maximum current also increased (FIG. 17). A time variance experiment (FIG. 18) demonstrates that this effect was independent of time. As shown in FIG. 19, a comparison of the two-run averaged fill characteristics between Chip A and Chip B remained relatively the same across fill conditions, demonstrating repeatability between chips.

This experiment demonstrated the versatility of the oligonucleotide-synthesis electrochemical chip as disclosed herein for detection of an exact liquid level inside of a flow cell cavity, and for quantitative measurement of fill profiles across various volume increments. These fill profiles showed minor variation between chips while maintaining the same linear profile across all fill conditions.

### Example 3: Electrochemical Liquid-Level Sensing (20 μL Fill Increments)

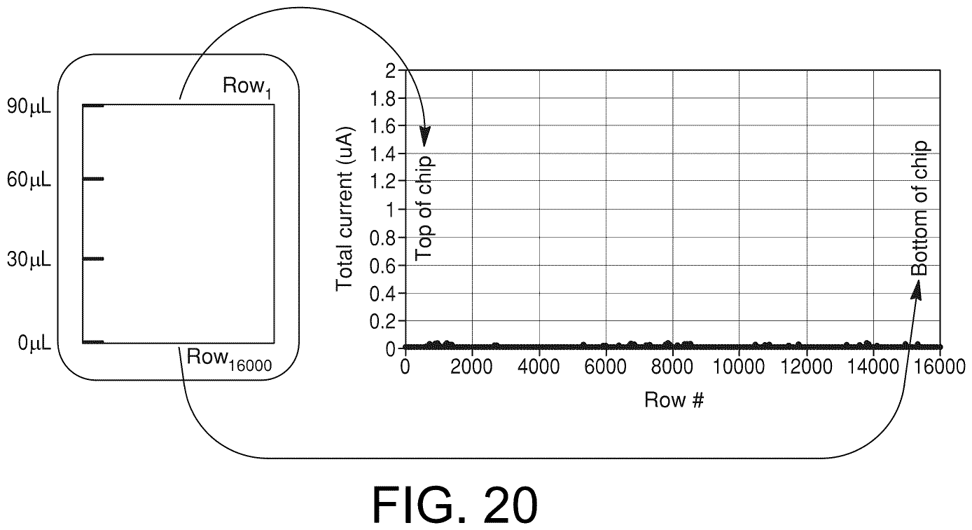

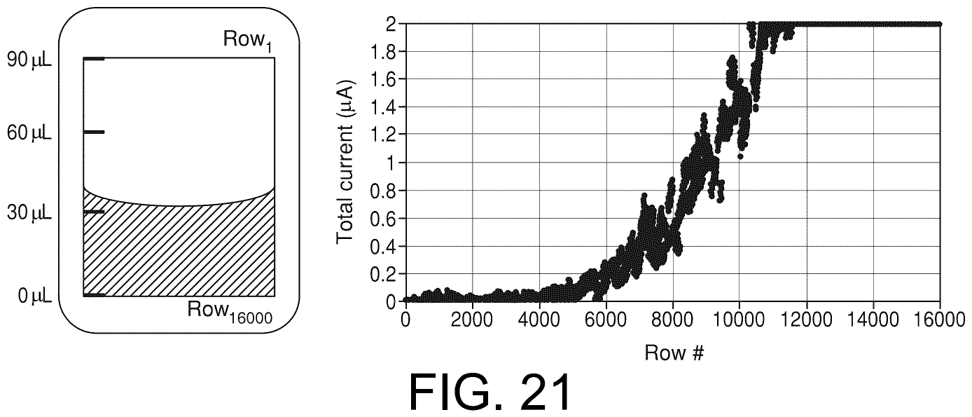

An experimental setup was assembling according to the experimental setup described in Example 1. A chip-health check was performed and a zero-current reading (FIG. 20) obtained according to the methods described in Example 1. Next, the manual valve was switched to the syringe pump to deliver 200 μL of electrochemically reactive solution to the flow cell at a flowrate of 20 μL/sec. This fill amount was used as an origin fill condition for determining level changes. A voltage pulse was then applied, and current measurements were recorded, logged, and processed for all 16,000 rows as an origin reading (FIG. 21).

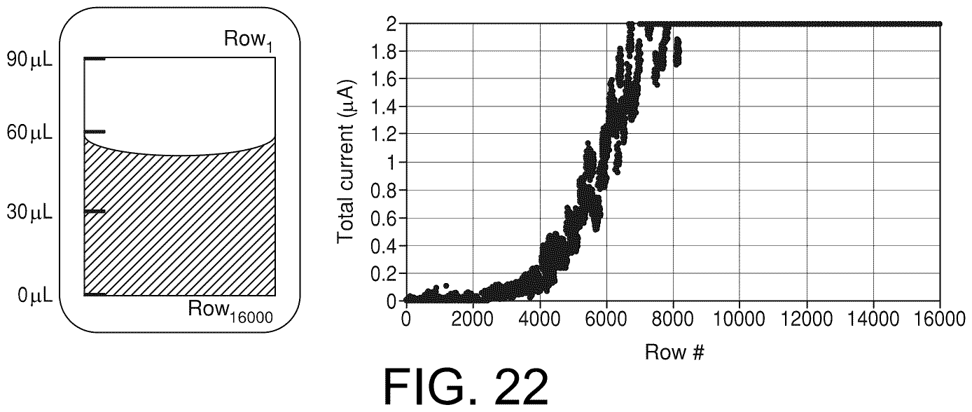

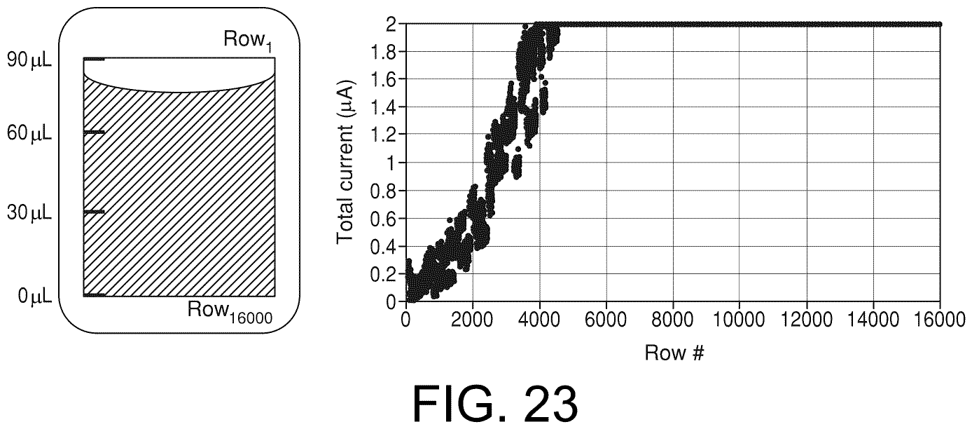

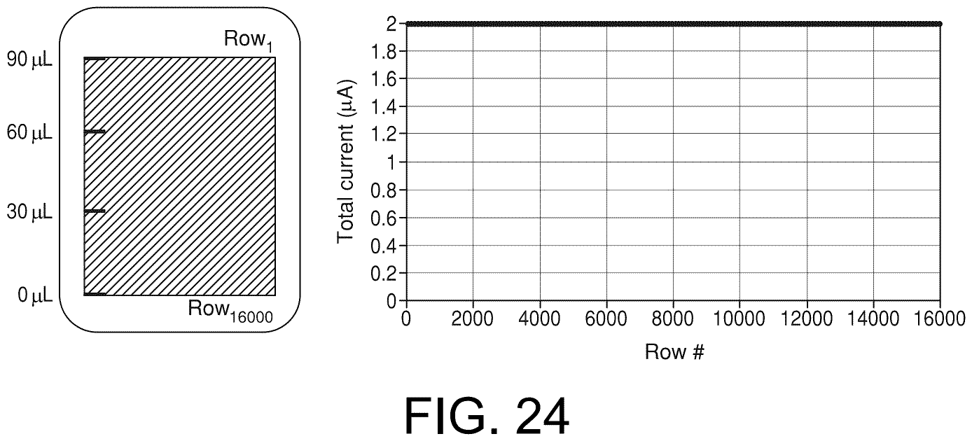

Next, 20 μL of electrochemically reactive solution was delivered to the flow cell at a flowrate of 1 μL/sec, voltage pulse applied, and current measurements recorded, logged, and processed for all 16,000 rows (FIG. 22). This step was repeated for another 20 μL increment (i.e., 40 μL from origin) and current measurements were recorded, logged, and processed for all 16,000 columns (FIG. 23). This step was repeated again to fully fill the flow cell and current measurements were recorded, logged, and process for all 16,000 columns (FIG. 24).

### Results

As incremental fills of 20 μL starting from baseline (origin) were added, the rows performing electrochemistry and providing maximum electrochemical current increased. As shown in the current plots in FIGS. 20-22, the curve shifts in the direction of liquid fill (i.e., from bottom of chip to top of chip). The slope-like front of the curve represents the dispersion boundary as the flow cell is filled, and contains a concentration gradient along that edge. As the fill volume increases, the dispersion front was observed to move further to the left of the current plots. As shown in FIG. 24, when all reaction sites were filled with electrochemically reactive solution and a filled flow state condition achieved (according to the methods described in Example 1), maximum current across all rows of the chip was observed. This successfully demonstrates the ability of the exemplary electrochemical chip to detect liquid level in the flow cell using an electrochemical output.

### Example 4: Electrochemical Fill Rate Measurement Inside a Flow Cell

The experimental setup as described in Example 1 was used with the following workflow to obtain a fill rate calibration curve. For ease of operation, the flow cell was held vertically (e.g., the orientation of the substrate and cavity was perpendicular to the platform it was fixed on. Fluidic connections were attached to the flow cell and electrical connections were interfaced with the electrochemical chip. A chip-health check was performed to determine and disable defective reaction sites. Acetonitrile was filled into the flow cell via the pressure-driven delivery mechanism and a voltage pulse applied to obtain a zero current reading. The manual valve was switched to the pump-driven delivery mechanism and electrochemically reactive solution was allowed to flow for 10 seconds at the flow rate being tested (100 μL/s to 200 μL/s). For a part of this duration, the electrochemically reactive solution was flowed to waste (by default) and flowed through the flow cell for the rest of the duration. At a known time point (t₀), the software script turned on the flow cell inlet valve and simultaneously turned on the DAC enabled for voltage application. In this manner, voltage application and current measurement were performed during a continuous fill event. Current was measured from the first row of every DAC group, leading to a total of 250 row values for current.

At the end of the specified voltage duration, the flow cell inlet was turned off and cocktail flowed to waste for the remainder of the 10 second duration. By controlling the inlet valve to the flow cell, to was kept consistent across fill conditions. Current was measured as the flow cell was being filled, and temporal data collected for 250 rows. Total time was recorded based on an inputted total number of samples to be collected at the beginning of a run.

After obtaining a calibration curve, the same experimental setup was used to determine an unknown fill rate as an electrochemically reactive solution was being supplied via the pressure-driven delivery mechanism. The above process was performed for six fill rate conditions: 100 μL/s, 120 μL/s, 140 μL/s, 160 μL/s, 180 μL/s, and 200 μL/s for a broad dynamic range curve for the instrument. The collected data was compared with an alternative means of determining fill rate by using a secondary flowmeter downstream of the flow cell. The fill rate conditions were selected to mimic the range offered by the pressure-driven delivery mechanism to be used for measuring an unknown fill rate. These experiments were performed three times (n=3) for Chip A and three times (n=3) for Chip B.

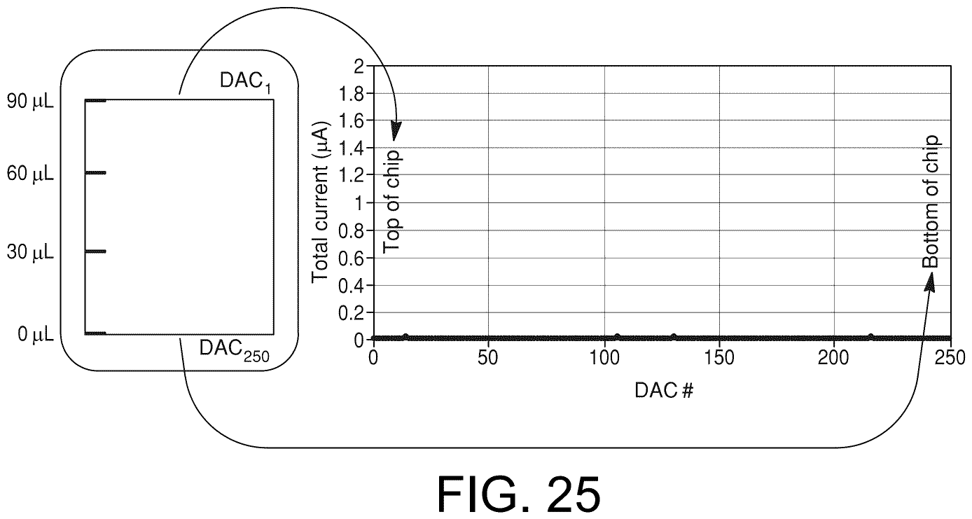

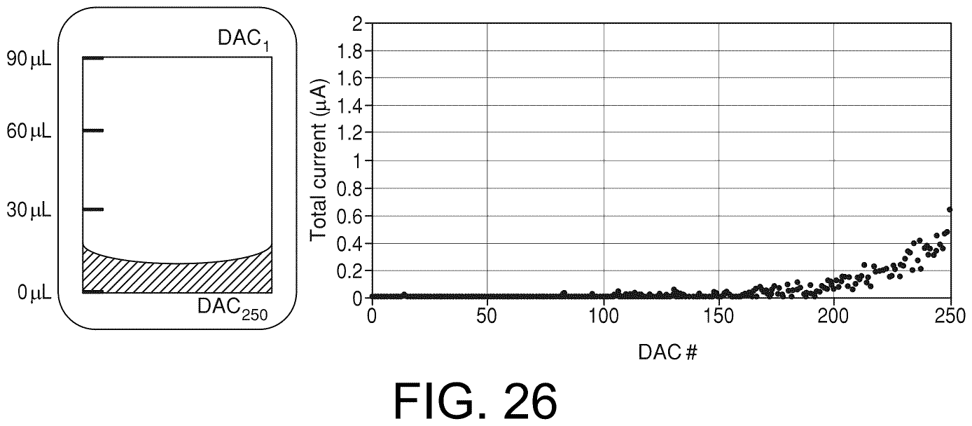

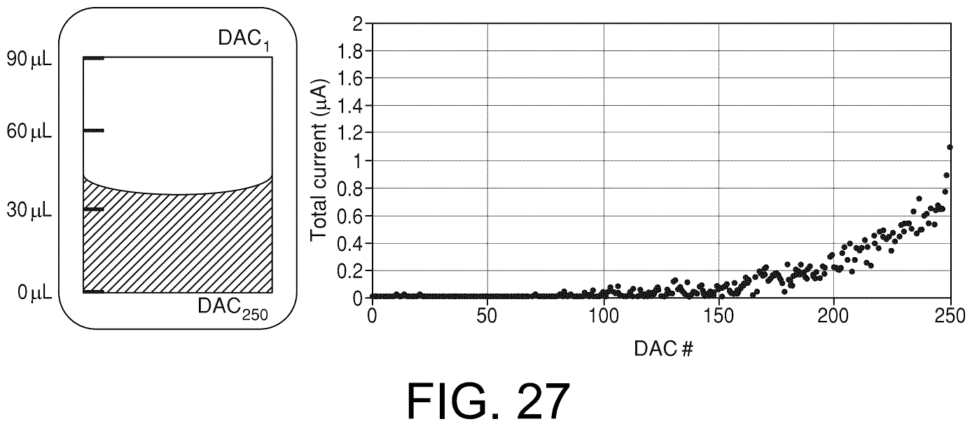

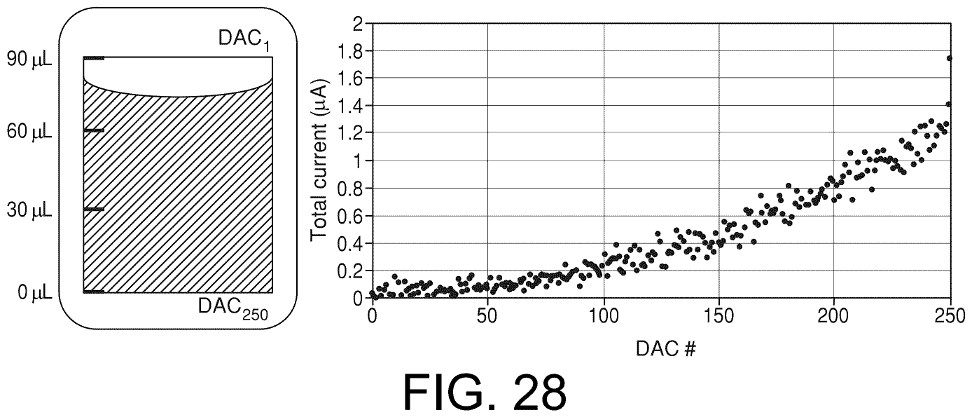

For the above experiments, only the first row of the 250 DAC groups were controlled and measured. Voltage was applied and current measured starting from the top of the chip (labelled as Row₁) and going to the bottom of the chip (labelled as Row₁₆₀₀₀). As shown in FIG. 25, at to, only diluent (acetonitrile) was present in the flow cell and no electrochemically reactive solution (e.g., electrochemically reactive solution) had yet been introduced. As shown in FIG. 26 (at time 700 ms), FIG. 27 (at time 945 ms), and FIG. 28 (at time 1500 ms), as time passed and the flow cell was continuously filled with electrochemically reactive solution, more DAC rows performed electrochemistry and thus generated electrochemical current. The slope of the front of the curve was observed to differ from the curves of the steady state fill experiments described above in Examples 1-3 because of a component of transience due to the continuous flow of liquid into the flow cell during voltage application.

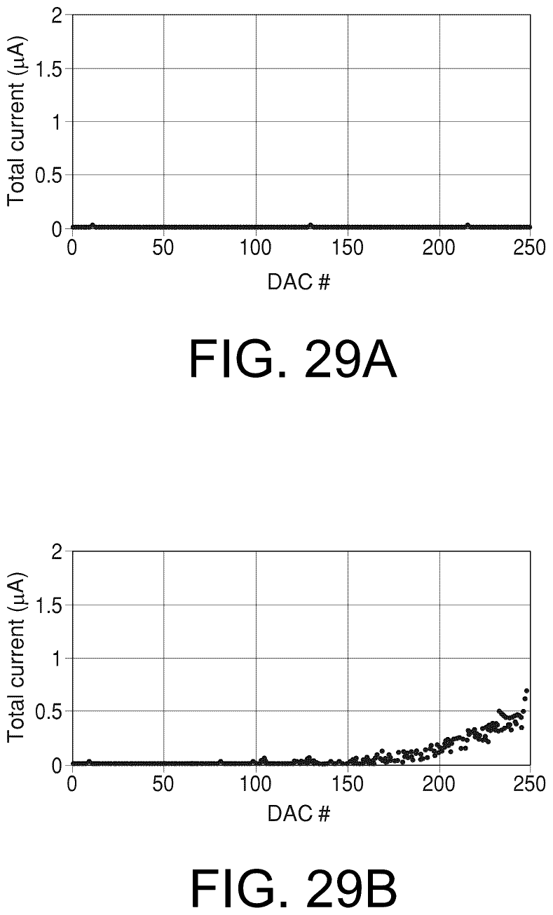

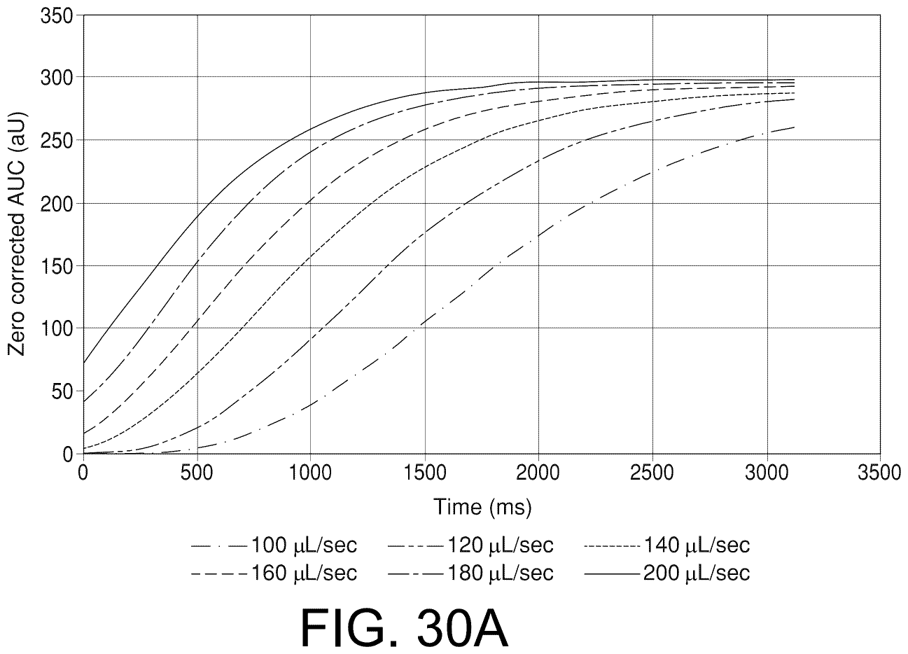

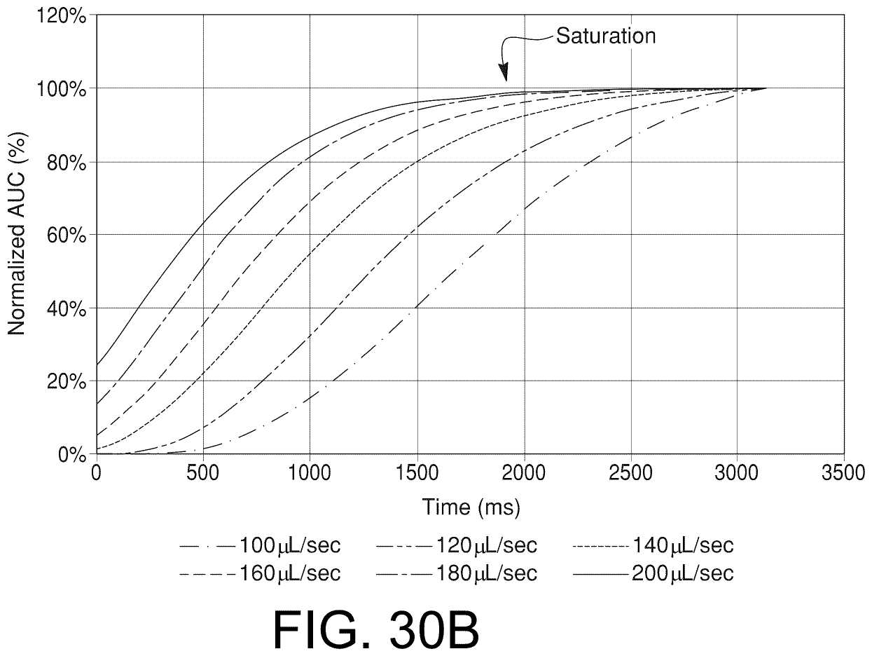

For each time point and for the zero current condition, area under the curve (AUC) was calculated and plotted as total current versus DAC row number, as described in Examples 1-4 above. The zero current condition (FIG. 29A) was subtracted for each time point (e.g., time 710 ms as shown in FIG. 29B) to generate a zero-corrected AUC values (FIG. 30A) which were then normalized to the final time point (FIG. 30B). Said methods were performed for all three runs to obtain a final calibration curve for fill rates for that electrochemical chip. The calibration curve allowed for convenient back-calculation of fill rate. For each fill rate condition, the time point at which 99% of the maximum normalized AUC value was used as the first time point for saturation (t₉₉%), and plotted against flow rate to obtain a linear calibration plot with decreasing slope. The t_{99%} time point was noted for all three runs and the linear calibration plot was used to back-calculate the unknown fill rate.

### Results

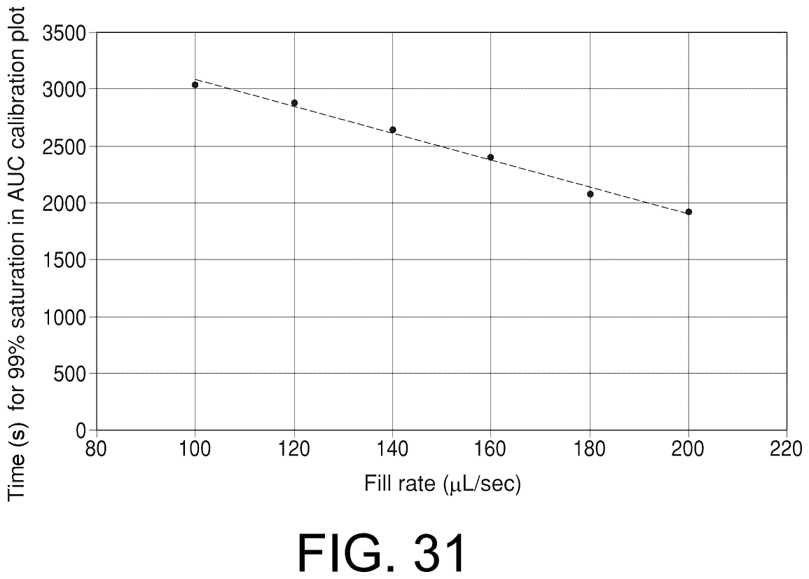

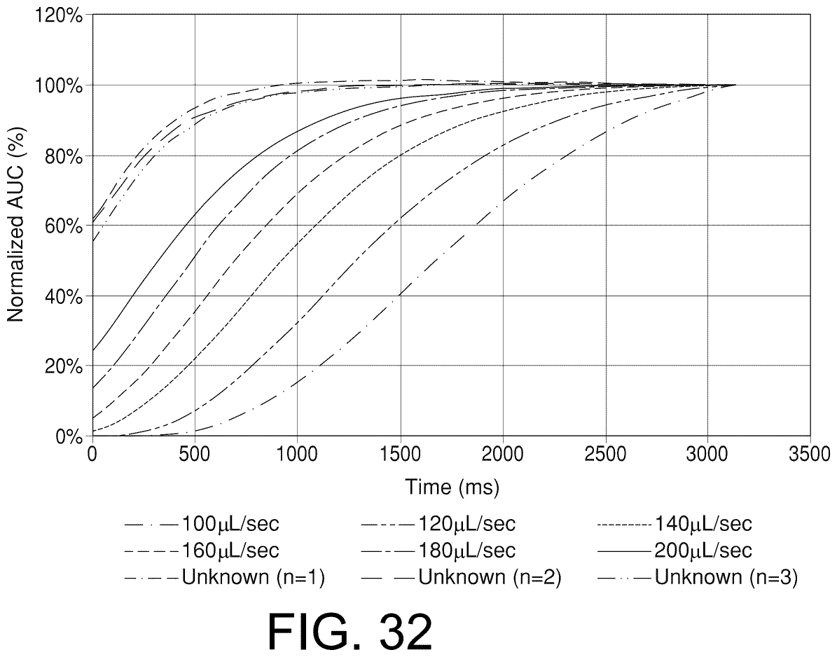

As shown in FIGS. 30A and 30B, as fill rate increased, starting points varied due to the different amounts of fill in the flow cell at to. All fill rate conditions eventually saturated since the flow cell was fully filled with concentration C₀ and was not in a transient state. Average intra-chip variance across the three runs was less than 10% overall (average CV values of 7% at 100 μL/s; 2% at 120 μL/s; 2% at 140 μL/s; 1% at 160 μL/s; 0% at 180 μL/s; and 1% at 200 μL/s). As shown in FIG. 31, obtaining t_{99%} and plotting against fill rates produced the linear calibration curves described above. Three runs were performed with pressure-driven delivery and Chip A for which normalized AUC analysis was performed and plotted against the calibration curve described earlier. As shown in FIG. 32, fill rates were back-calculated for the three runs (293.86 μL/s, 266.67 L/s, and 259.88 μL/s) to obtain an average reading of 273.47 μL/s (standard deviation of 14.68 μL/s and current variance of 5%). This reading was corroborated by the secondary flow rate measurements made via the downstream flowmeter.

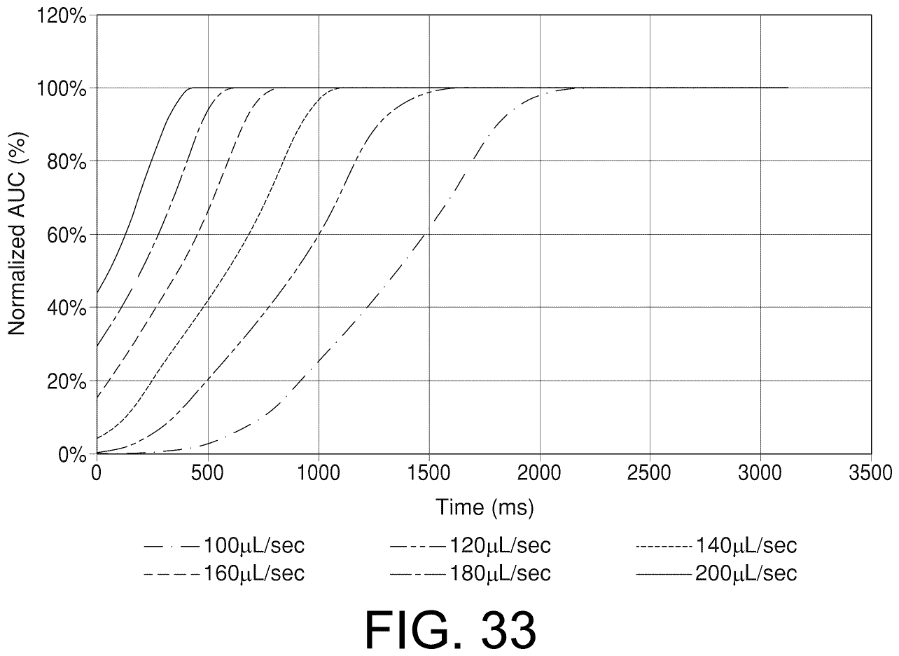

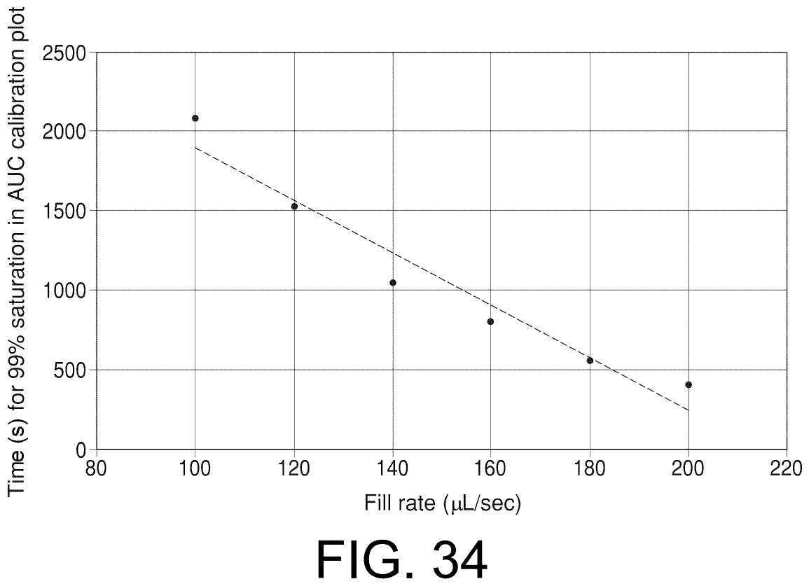

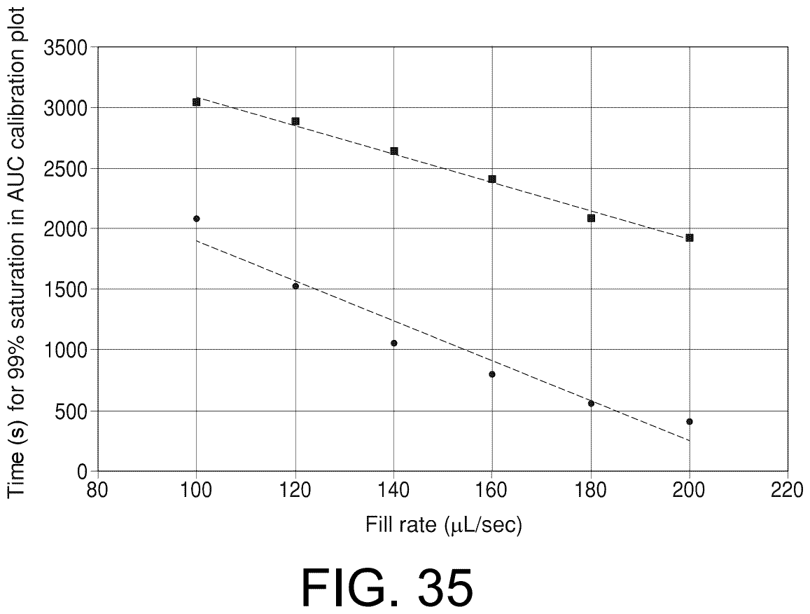

The same methods were used to perform two runs on Chip B and produce a plot of normalized AUC values (FIG. 33) averaged across the two runs and a plot of time to saturation versus fill rates (FIG. 34). The observed linear trend for Chip B was similar to that of Chip A (average CV values of 4% at 100 μL/s and at 120 μL/s; 0% at 140 μL/s, 160 μL/s, 180 μL/s, and 200 μL/s). As shown in FIG. 35, linear calibration plots varied in slope and intercept between Chip A and Chip B, demonstrating the necessity of performing a calibration curve for each unique chip. This experiment further demonstrates that once the calibration curve is generated, it can be used to reliably determine unknown fill rates.

### Example 5: Determination of Fill Percentage in a Flow Cell

The experimental setup and workflow described above in Examples 1-4 were used to obtain a zero current reading. A quantity of 120 μL of electrochemically reactive solution was delivered at a flowrate of 20 μL/s to fill up tubing and system volumes going up to the flow cell. Next, a quantity of 40 μL of electrochemically reactive solution was delivered to the flow cell, a voltage pulse applied, and current measured, logged, and processed for all 16,000 rows. This process was performed three more times to represent three different fill levels (40 μL, 80 μL, and 120 μL). The manual valve was switched to the pressure-driven delivery mechanism, flow cell washed twice with acetonitrile, and flow cell dried. Downstream processing and data analysis were performed to calculate fill percentage inside the flow cell.

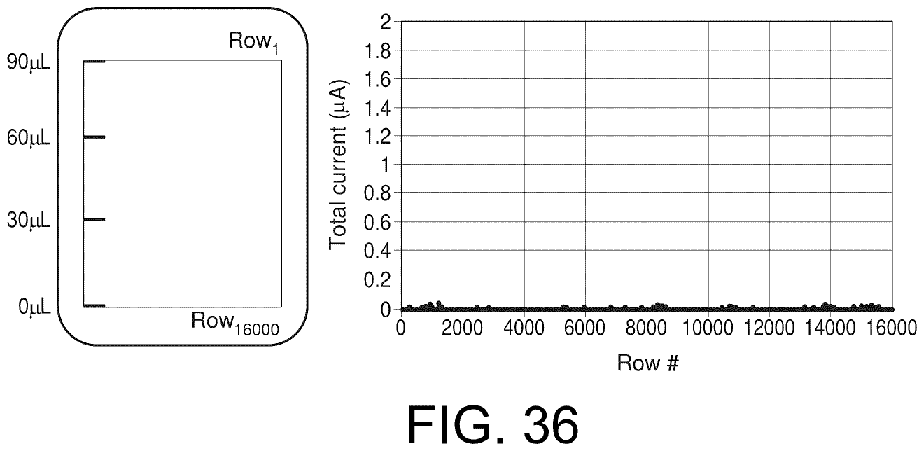

For the zero current condition (acetonitrile only), the 99.99^{th} percentile value was calculated and chosen as a threshold value for comparison (FIG. 36). For each fill condition, current values for every row were compared against the threshold value and converted to a value of 1 if the current was greater than threshold, and converted to a value of 0 if the current was equal to or less than threshold. For any fill condition, the sum of all compared values (net current) was obtained and percent fill (% fill) was calculated by taking a ratio of the calculated sum and the total number of rows measured:

$$percent fill = \frac{sum of rows with converted value of 1}{16000} \times 100 \qquad ( Equation 5 )$$

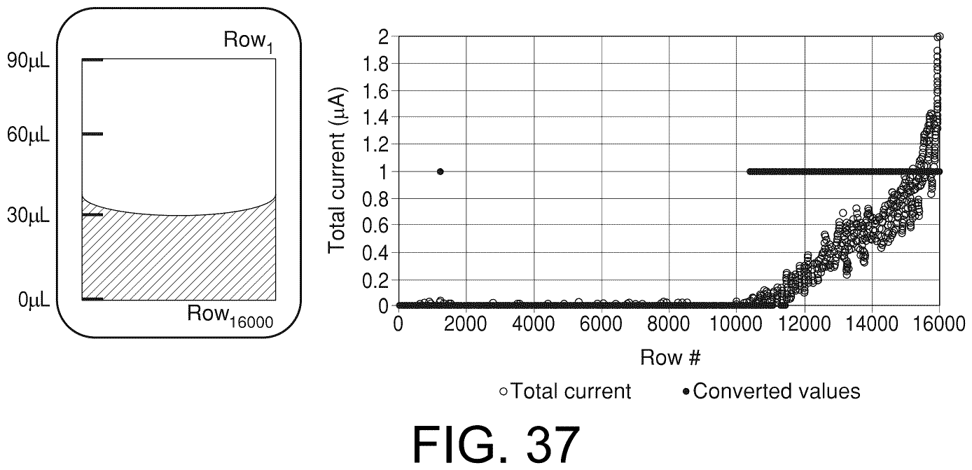

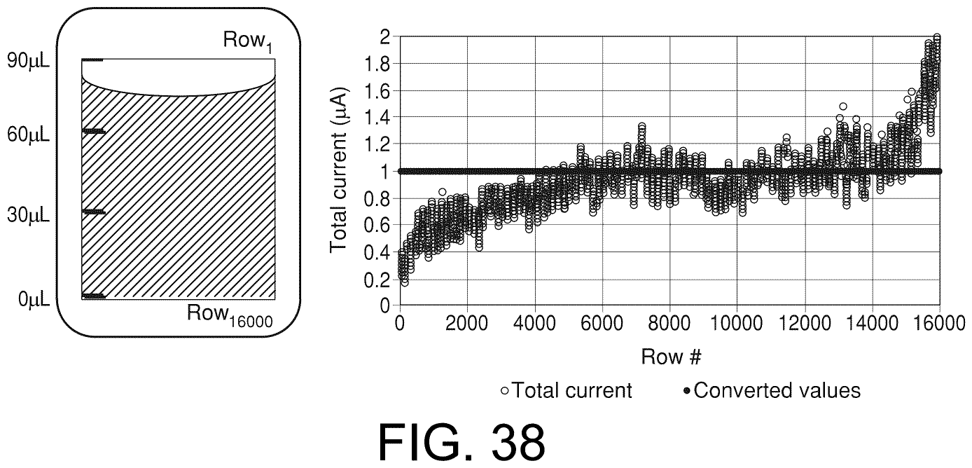

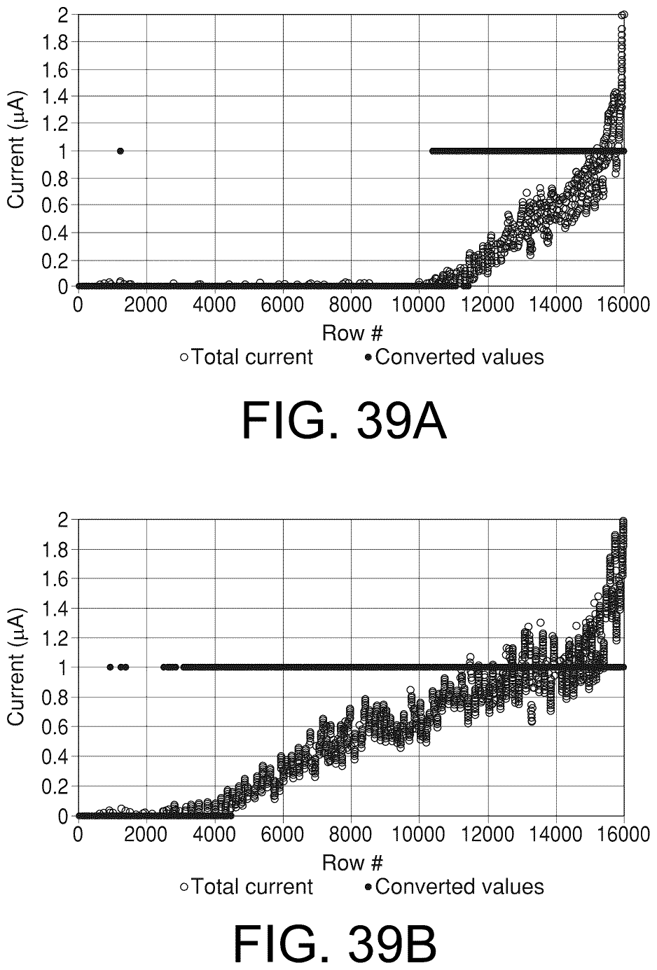

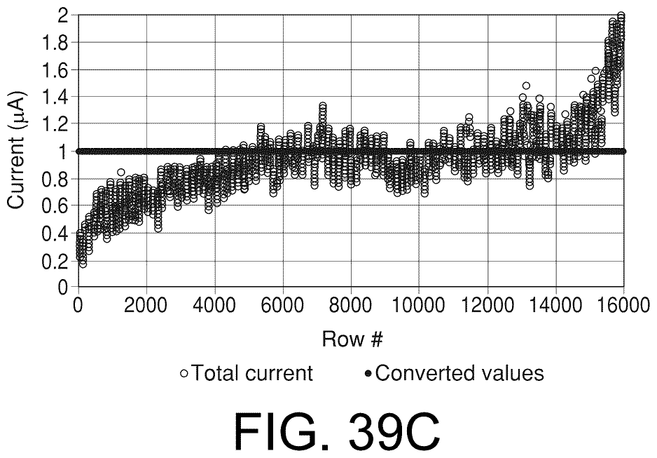

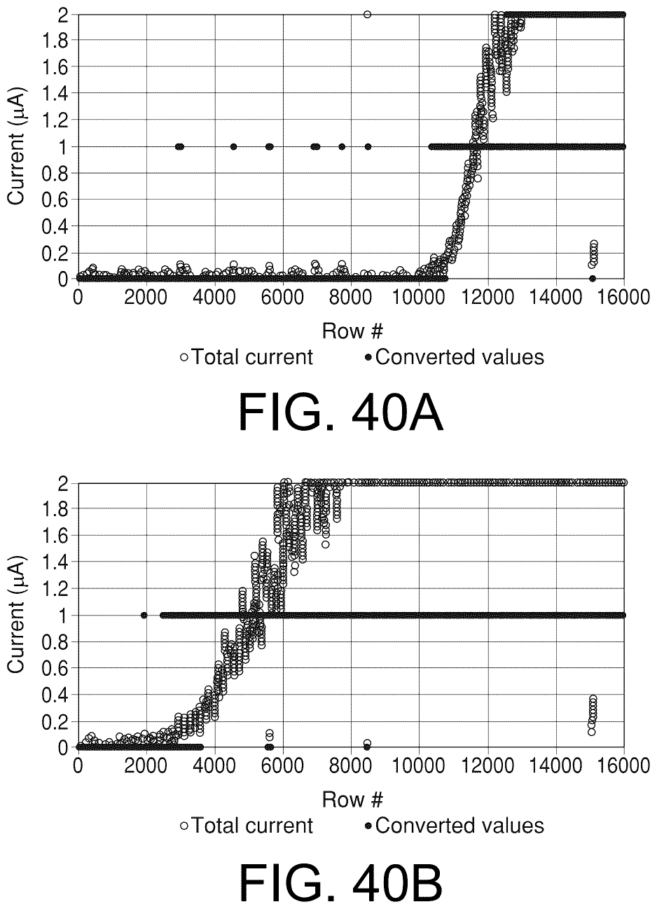

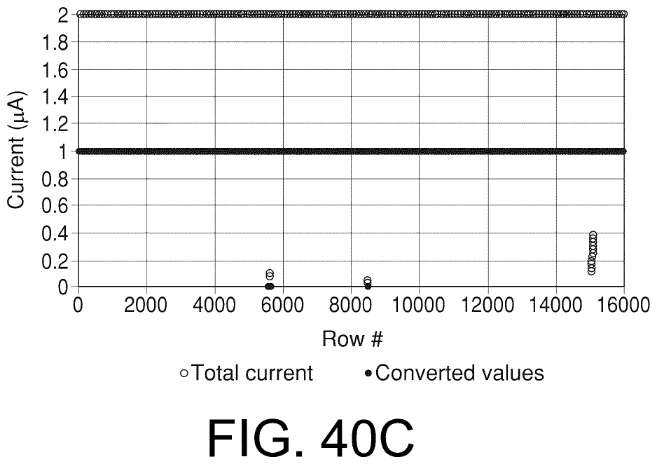

As shown in FIG. 37, illustrating a partially-filled flow cell, not all 16,000 rows exhibited net currents greater than threshold, allowing for calculation of a fill percentage. As shown in FIG. 38, illustrating a fully-filled flow cell, all 16,000 rows exhibited net currents of greater than threshold, as corresponding to the 100% filled condition. Experiments as described above were performed using Chip A to determine fill percentage at 40 μL, 80 μL, and 120 μL volumes (FIGS. 39A, 39B, and 39C, respectively). The same experiments were performed using Chip B (FIGS. 40A, 40B, and 40C, respectively). The number of rows encountering the electrochemically reactive solution exactly mapped with the fill levels in the flow cell thereby proving this method can be a reliable means of distinguishing between partially and fully filled flow cells, as shown in Table 1, below.

TABLE 1

| | Volumetric Fill | Total Sum of | | |
|---|---|---|---|---|
| Chip | (μL) | Rows | Percent Fill | Verdict |
| Chip A | 40 | 5,217 | 33% | Partially filled |
| | 80 | 12,477 | 78% | Partially filled |
| | 120 | 16,000 | 100% | Fully filled |
| Chip B | 40 | 5,453 | 34% | Partially filled |
| | 80 | 13,100 | 82% | Partially filled |
| | 120 | 15,921 | 100% | Fully filled |

This experiment demonstrated the versatility of the oligonucleotide-synthesis electrochemical chips described herein for quantitative determination of percent fill inside a flow cell. The exact percent fill of reagent can be determined so as to provide a quality control tool for identifying improperly-filled flow cells. These methods can be used in any process requiring monitoring of reagent fill inside of a flow cell and/or over a substrate.

### Example 6: Effective Detection and Measurement of Fluid Flow Characteristics Independent of Flow Cell Shape and Architecture

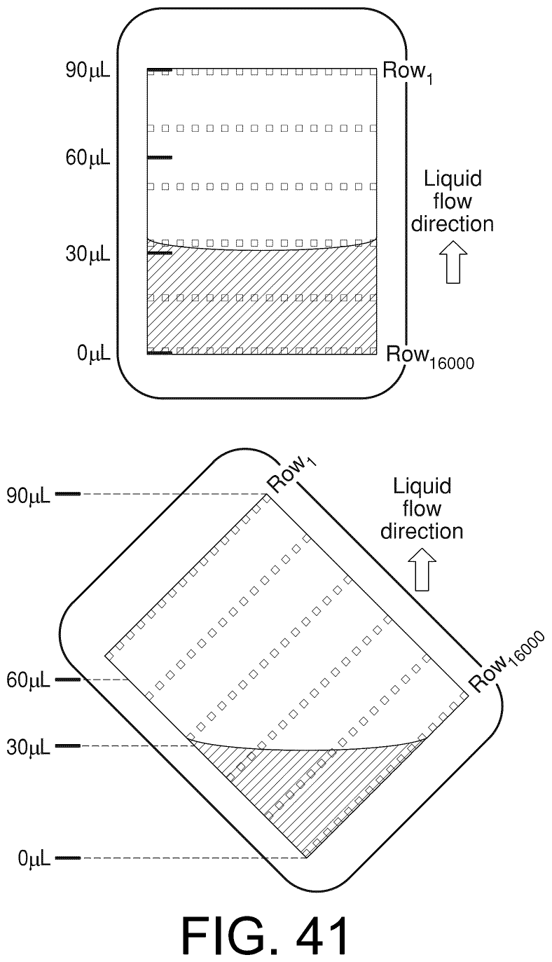

The experimental setup described in Examples 1-4 for two flow cells (FC1 and FC2) was modified to adjust flow cell shape by rotating the cavity by 45° and by changing fluidic architecture. Reaction area between the two flow cells and fluid delivery pathway were kept consistent. FC2 was rotated by 45° relative to FC1, such that in contrast to FC2, in FC1, fluid flow and voltage application rows followed the same direction (FIG. 41). The workflow described in Examples 1-4 was performed under fill conditions of 1 μL and 10 μL in both flow cells. The workflow described in Example 5 was performed to measure percent fill in FC2.

Described below is a pictorial view of the filling of FC 2 and the total current as a function of row for a 10 μL fill.

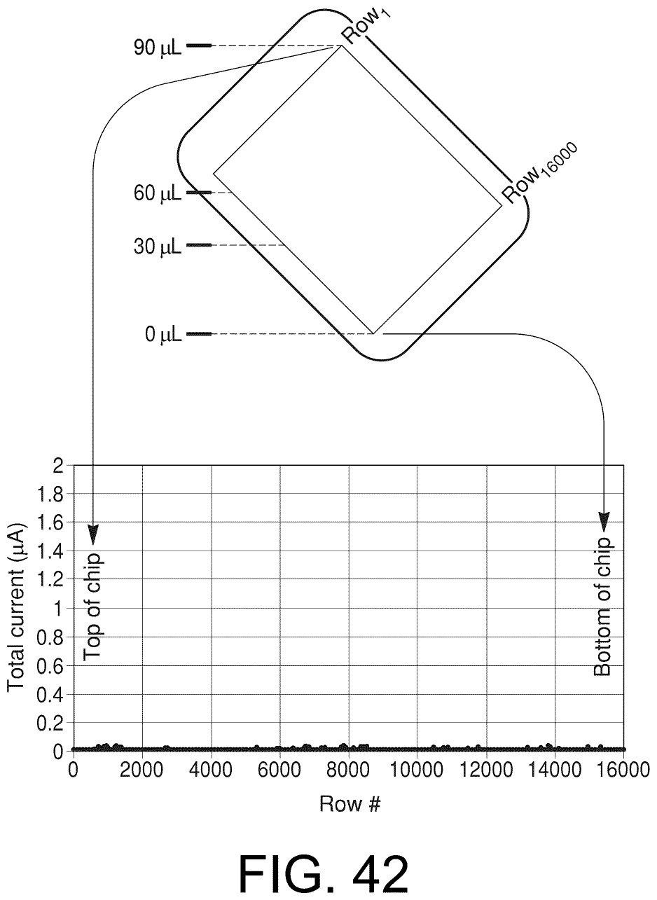

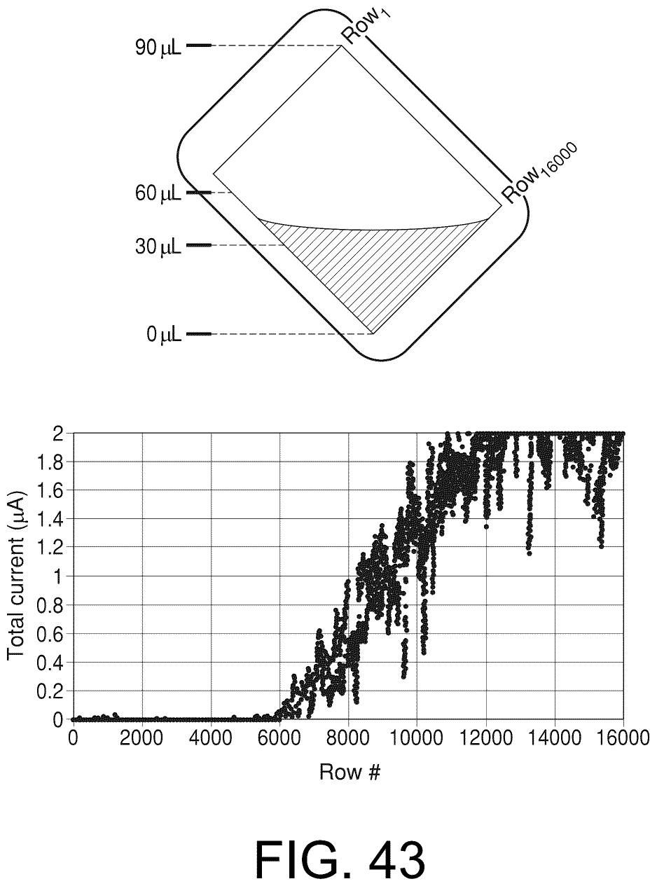

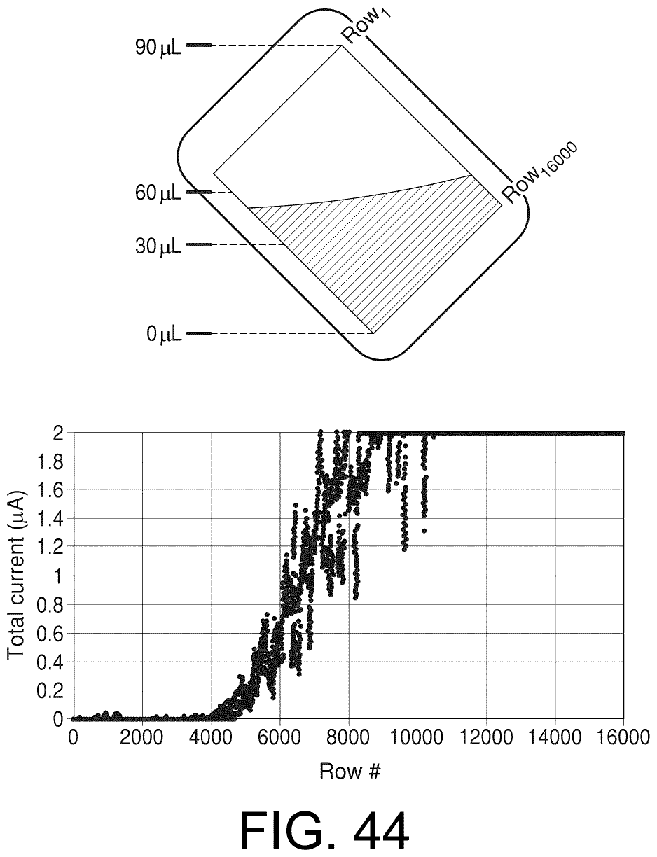

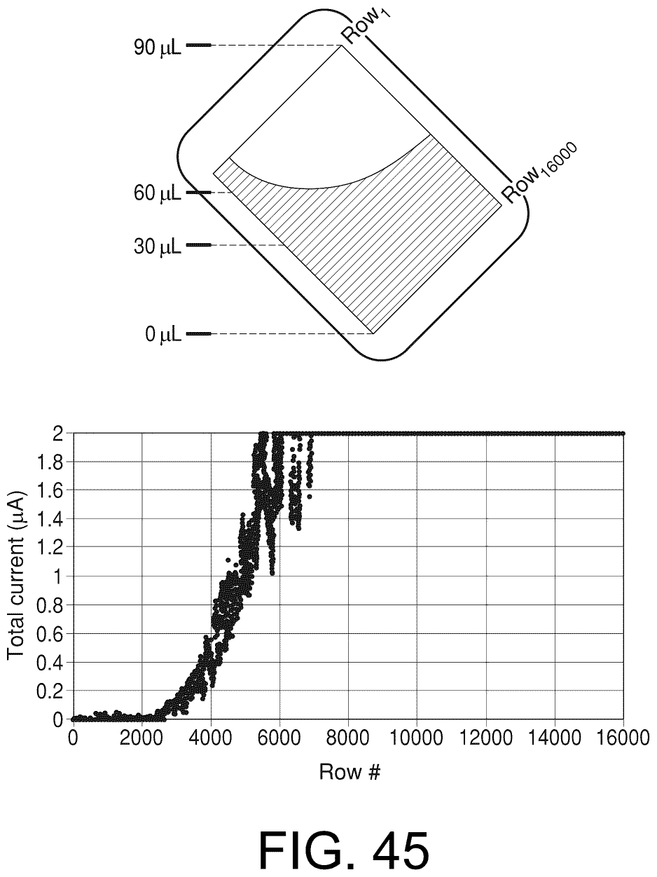

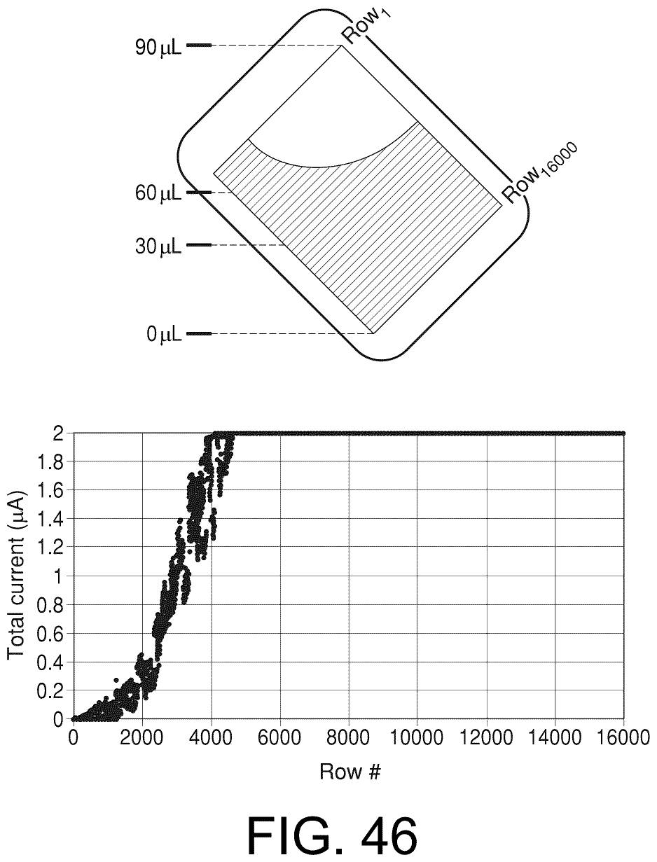

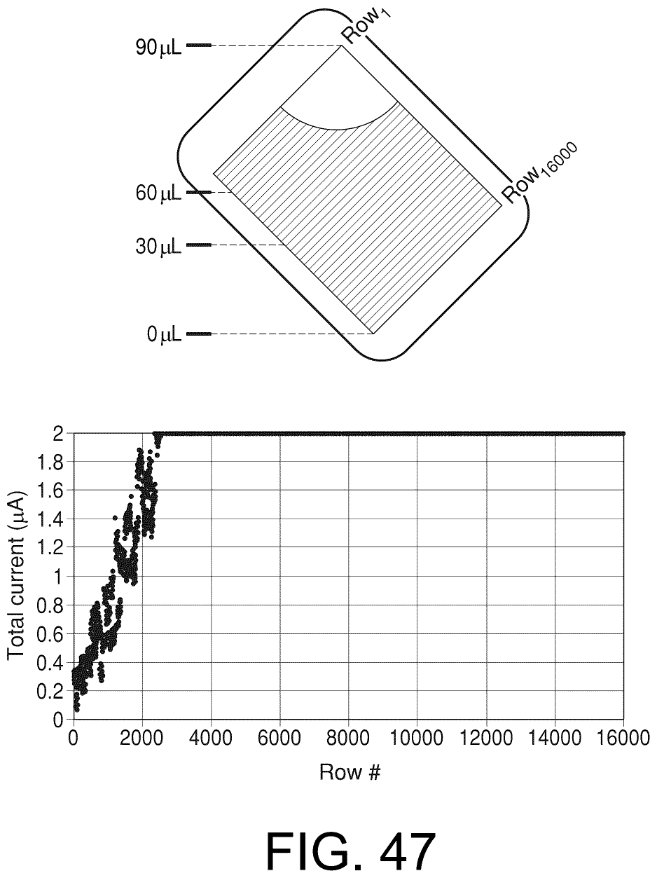

As shown in FIG. 42, for the 10 μL fill condition, voltage application and current measurement rows were counted from top of chip to bottom of chip in FC2. Fluid flow direction in FC2 was not perpendicular to the voltage-application rows, as in the case of FC1. Accordingly, different portions of the same voltage row may be filed by different amounts of electrochemically reactive solution for subsequent fills, and it may not be fully saturated to the maximum current at a certain fill. As shown in FIG. 43, baseline or origin condition represented starting point from which fill increments were tested. As shown in FIG. 44, FIG. 45, FIG. 46, and FIG. 47, as incremental fills of 10 μL were performed from baseline, the rows providing maximum current increased, and the curve shifted in the direction of liquid fill (i.e., from bottom of chip to top of chip). The slope-like front of the curve moved further towards the left with each fill. This front dispersed at lower fills and became less dispersed as the flow cell approached a fully-filled state. This was considered an artifact of the directional order of the fluid flow direction and voltage rows. As the fill of the flow cell increased, the more the voltage rows become fully filled with electrochemically reactive solution at maximum concentration C₀, thereby giving maximum currents on averaging.

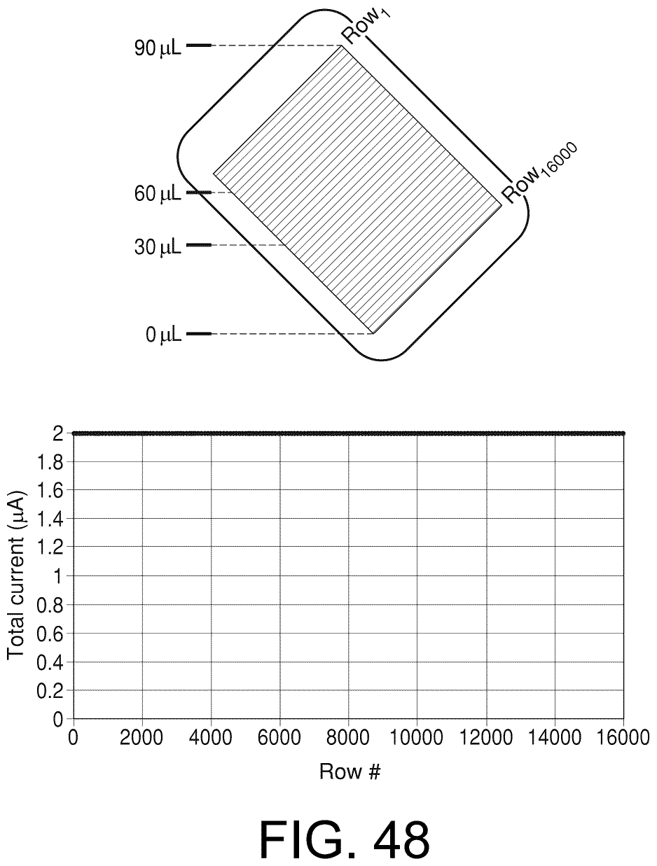

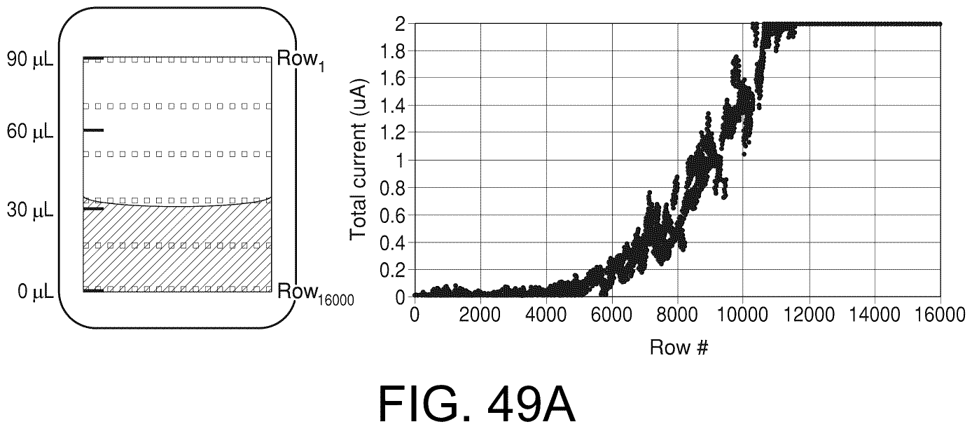

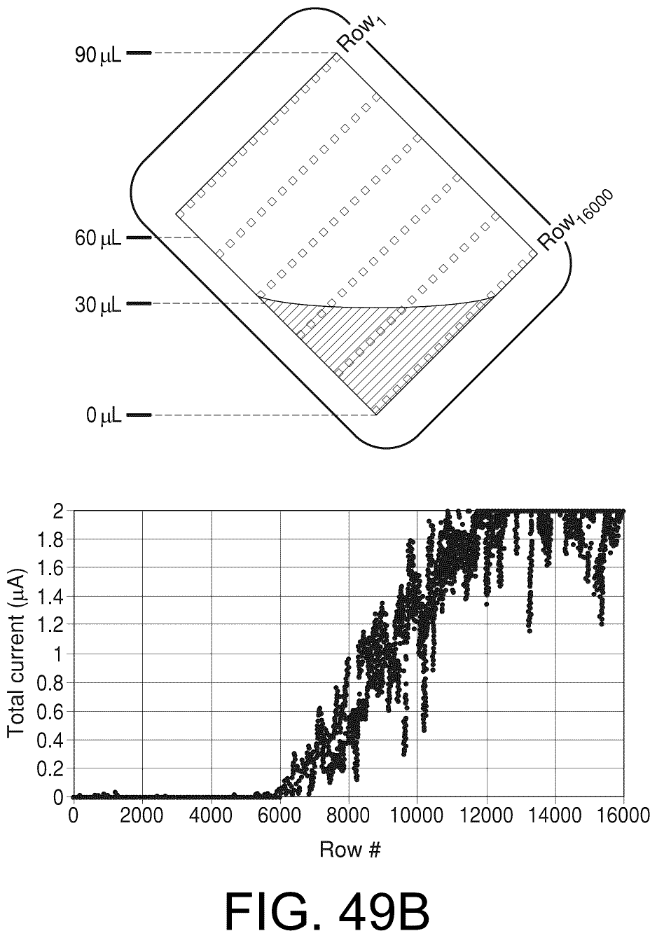

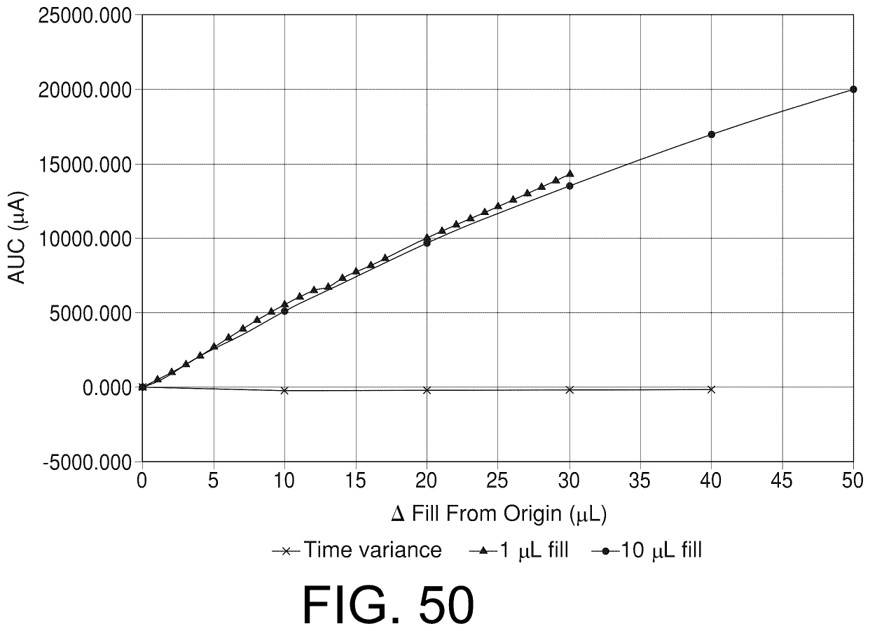

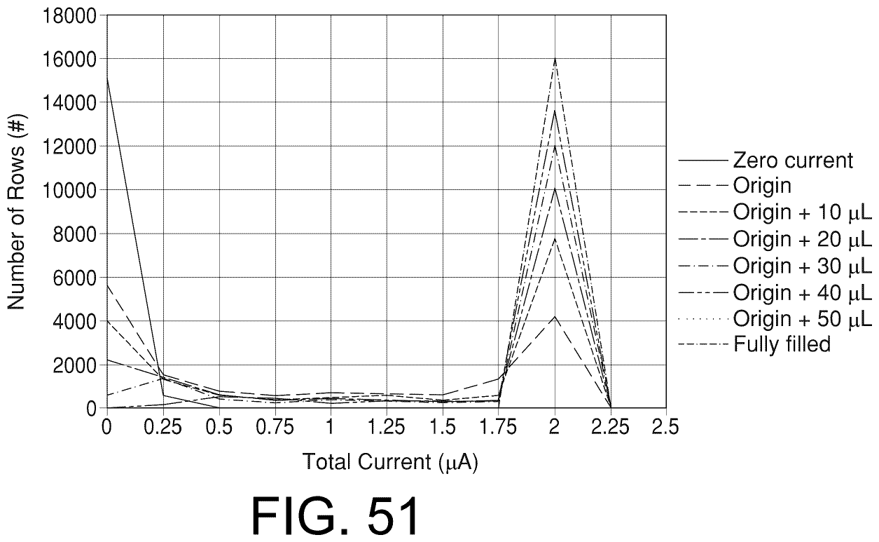

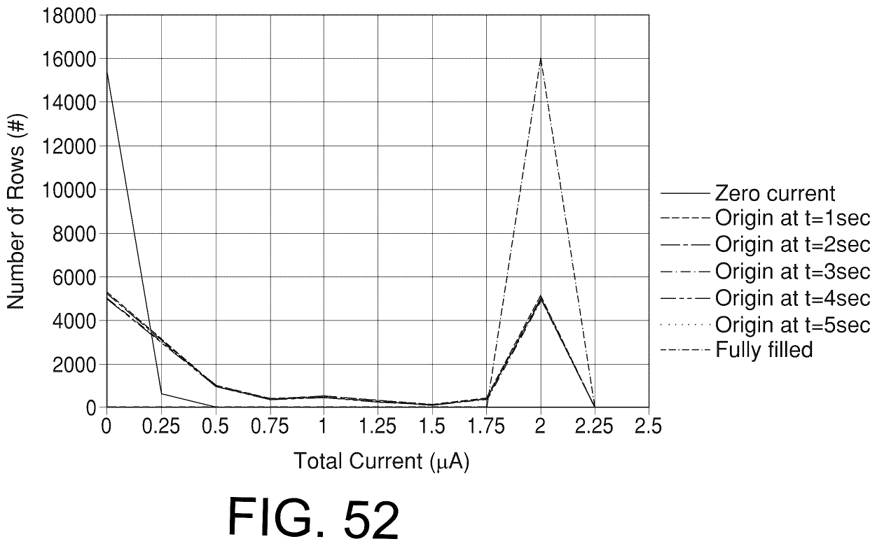

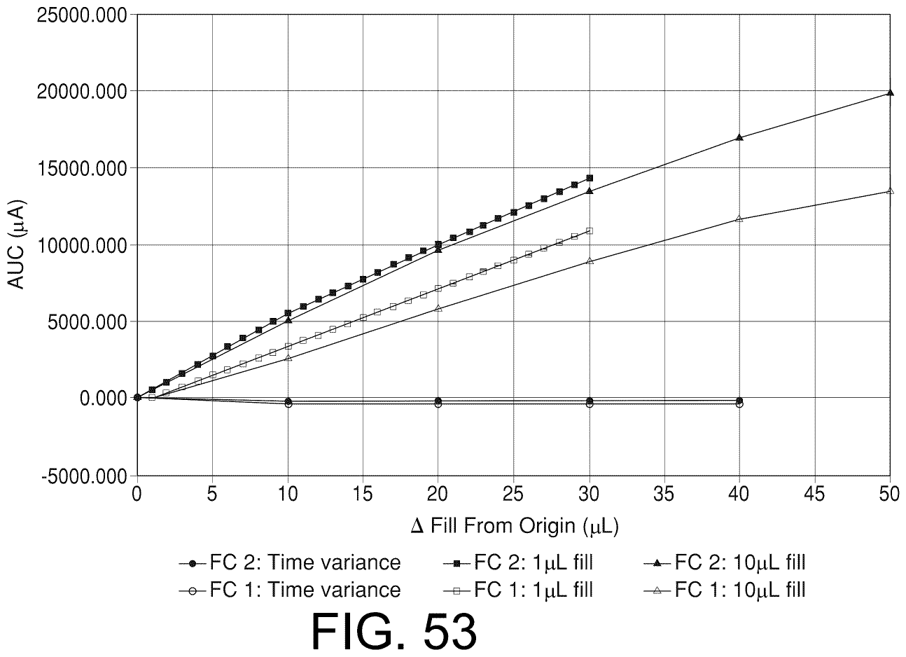

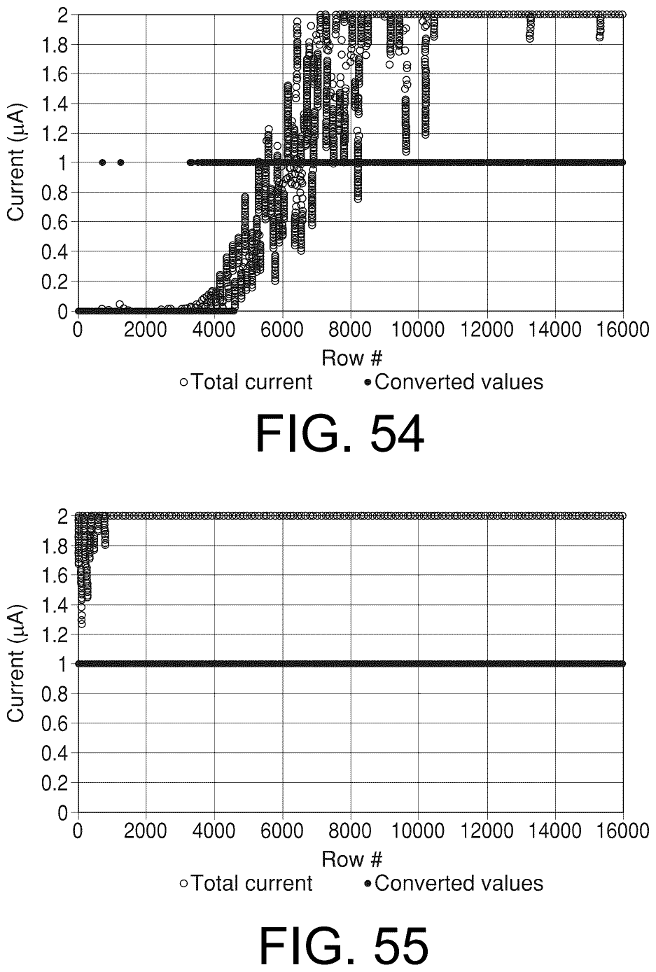

As shown in FIG. 48, when all the reaction sites and rows were filled with electrochemically reactive solution, the maximum current across the entire chip may be obtained signifying a fully filled state. When comparing the origin graph for FC1 (FIG. 49A) and FC2 (FIG. 49B) for the same chip, variances were observed between the two flow cells. Specifically, greater dispersion was observed in FC2 than in FC1 due to the fact that not all 16,000 reaction sites on a row may be filled with electrochemically reactive solution during a fill. As shown in FIG. 50, AUC analysis was performed for incremental fills using Chip A, allowing for detection and measurement of incremental fills as a function of fill-from-origin for fill volume increments of 1 μL and 10 μL. As shown in FIG. 51 and FIG. 52, histogram analysis was performed for all fill increments and time variance experiments. Similar outcomes were observed between FC1 and FC2, such that number of rows generating maximum faradaic current increased as the flow cell was increasingly filled with electrochemically reactive solution in 10 μL increments. As shown in FIG. 53, averaged fill characteristics were observed to be linear for both FC1 and FC2, but did not demonstrate the same slope and intercept values between the flow cells. As shown in FIG. 54 (80 μl fill) and FIG. 55 (120 μL fill), the number of rows in FC2 encountering electrochemically reactive solution exactly mapped with fill levels in the flow cell.

This successfully demonstrated the ability of the electrochemical chips as described herein to detect liquid level using an electrochemical output regardless of shape or orientation.

### Example 7: Flow Cell Network

The methods described above of using the electrochemical chip as a multipurpose sensor for detecting and measuring fluid flow characteristics (fill level and fill rate) can be applied to a network of flow cells. Such a network can reduce hardware, costs, maintenance, calibration, complexity and effort in multiplexing. The following application areas may prove useful when scaling up this methodology to multiple flow cells.

Applying this methodology to multiple flow cells can allow for fill and level detection in flow cell(s) along various banks to ensure complete reagent fills in every bank during multiple reagent cycles within a run and across several runs. Fill rate determination in every flow cell can be used to ensure equal fill rates in certain configurations; can be useful for testing serial, parallel or combination networks; can be used as a tool for measuring pressure and fill rate differences between flow cells: within a bank and between banks; and can be used for studying fill rate impact on synthesis quality in a system with modifiable flowrates. Further, this methodology can be used to identify partially-filled flow cells in a network, troubleshoot, systemic issues, and disable defective flow cells during operation.

1. A method of determining conditions of an electrochemical chip comprising a plurality of reaction sites, the method comprising:
delivering a diluent to a flow cell assembly comprising the electrochemical chip;
for each reaction site of the plurality of reaction sites, measuring a background current;
delivering an electrochemically reactive solution to the flow cell assembly;
for each reaction site of the plurality of reaction sites, applying a voltage pulse; and
for each reaction site of the plurality of reaction sites, measuring a current corresponding to the reaction site.

2. The method of claim 1, wherein the flow cell assembly comprises:
one or more fluid ports;
one or more manifolds, connected to the one or more fluid ports; and
one or more distributors, connected to the one or more manifolds, wherein the one or more distributors is configured to transfer fluid from the one or manifolds to the plurality of reaction sites.

3. The method of claim 1, wherein applying the voltage pulse comprises:
sending a digital input to a Digital to Analog Converter (DAC) interfaced with an electrical interface of the electrochemical chip;
converting, via the DAC, the digital input to a voltage output; and
delivering the voltage output to each reaction site of the plurality of reaction sites.

4. The method of claim 1, wherein measuring a current corresponding to the reaction site comprises:
sending a current generated at each reaction site to an Analog to Digital Converter (ADC) interfaced with an electrical interface of the electrochemical chip, the current at each reaction site generated using at least one electrode at each reaction site;
converting, via the ADC, the generated current to a digital output; and
delivering the digital output to a computing device.

5. The method of claim 1, further comprising, before delivering diluent reagent to the flow cell assembly:
iteratively sampling current values at a plurality of reaction sites of the electrochemical chip;
identifying a subset of reaction sites at which current is not generated as expected; and
disabling the subset of reaction sites.

6. The method of claim 1, further comprising, after measuring a current at each of the plurality of reaction sites:
washing the plurality of reaction sites with diluent reagent;
drying the plurality of reaction sites.

7. The method of claim 6, wherein the diluent reagent is delivered to the flow cell assembly via a pressure-driven delivery mechanism.

8. The method of claim 1, wherein the electrochemically reactive solution is delivered to the flow cell assembly via a pump-driven delivery mechanism.

9. The method of claim 1, wherein the electrochemically reactive solution is delivered to the flow cell assembly in a total volume of about 10 μL to about 1,000 μL.

10. The method of claim 1, further comprising:
subtracting the background current from the measured currents at a selected fill volume to generate a corrected current value for each reaction site of the plurality of reaction sites;
plotting the corrected current values as a function of reaction sites;
summating all corrected current values on the plot to generate an area under the curve (AUC) value; and
normalizing the AUC value to the background current value to generate a normalized AUC value.

11. The method of claim 10, further comprising determining a fill rate, liquid level, or fill percentage of the electrochemically reactive solution in the flow cell assembly by comparing the normalized AUC value to a calibration curve of normalized AUC values, wherein the calibration curve is generated by plotting two or more normalized AUC values of two or more known fill conditions.

12. A flow cell assembly for oligonucleotide synthesis, comprising:
a flow cell bottom;
a flow cell top in contact with the flow cell bottom; and
an electrochemical chip situated in a recess in the flow cell bottom, wherein the electrochemical chip comprises a plurality of reaction sites, wherein each reaction site comprises a microwell comprising two electrodes, the two electrodes configured to deliver voltage to and measure current from the reaction site;
an electrical connection configured to transmit a signal to and/or from the electrochemical chip; and
a flow cell top in contact with the flow cell bottom, wherein the flow cell top comprises an aperture configured to receive the electrical connection.

13. The flow cell assembly of claim 12, wherein the flow cell top comprises:
a first manifold extending from a first fluidic port to a first distributor; and
a second manifold extending from a second fluidic port to a second distributor.

14. The flow cell assembly of claim 13, wherein the first manifold further extends from the first distributor to a third fluidic port.

15. The flow cell assembly of claim 12, wherein the plurality of reaction sites are arranged in an array of rows and columns within an active area of the electrochemical chip, and wherein a pitch between adjacent reaction sites is about 0.01 μm to about 100 μm.

16. The flow cell assembly of claim 12, wherein the plurality of reaction sites are arranged in an array of rows and columns within an active area of the electrochemical chip, and a pitch between adjacent reaction sites is about 1 μm.

17. The flow cell assembly of claim 12, wherein the electrochemical chip further comprises an electrical connection, the electrical connection configured to transmit a signal from a computing device to the electrochemical chip.

18. The flow cell assembly of claim 12, wherein the electrochemical chip further comprises an electrical connection, the electrical connection configured to transmit a signal from the electrochemical chip to a computing device.

19. A network of flow cell assemblies for oligonucleotide synthesis, comprising at least two flow cell assemblies according to claim 11, wherein the at least two flow cell assemblies are fluidically connected.

20. The network of claim 19, wherein the at least two flow cell assemblies comprise a first flow cell assembly and a second flow cell assembly, and the network is configured to pass fluid from the first flow cell assembly to the second flow cell assembly.

21. A system, comprising:
a flow cell including an electrochemical chip, the electrochemical chip including a plurality of reaction sites arranged in one or more parallel rows, each reaction site of the plurality of reaction sites including a microwell configured to receive a fluid; and
a computing device operatively coupled to the electrochemical chip, the computing device configured to:
selectively deliver electrical input to an electrode at each reaction site of the plurality of reaction sites; and
selectively receive electrical input from the electrode at each reaction site of the plurality of reaction sites to determine at least one of a liquid level, a fill percentage, or a flow rate of the fluid inside of the flow cell.

22. The system of claim 21, wherein the fluid includes an electrochemically reactive solution configured to facilitate an electrochemical reaction at the plurality of reaction sites, the electrochemically reactive solution including at least one of a reduction reactant, an oxidation reactant, a base, an electrolyte, or a diluent.

23. The system of claim 21, further comprising:
a liquid delivery system including:
a fluid port coupled to the flow cell, the fluid port configured to communicate the fluid to and from an exterior of the flow cell;
a manifold coupled to the fluid port; and
a distributor coupled to the manifold, the distributor configured to selectively distribute the fluid to the plurality of reaction sites.

24. The system of claim 23, wherein the liquid delivery system includes a pressure-driven mechanism.

25. The system of claim 23, wherein the liquid delivery system includes a pump-driven mechanism.

26. The system of claim 21, wherein the plurality of reaction sites are arranged in an array of rows and columns on the electrochemical chip such that a pitch between adjacent reaction sites is in a range of about 0.01 μm to about 100 μm.

27. The system of claim 21, wherein the computing device is further configured to:
before delivering diluent reagent to the flow cell, iteratively sampling current values at a plurality of reaction sites of the electrochemical chip;
identifying a subset of reaction sites at which current is not generated as expected; and
disabling the subset of reaction sites.

28. The system of claim 21, wherein the computing device is further configured to:
subtracting a background current from measured currents at each reaction site of the plurality of reaction sites at a selected fill volume to generate a corrected current value for each reaction site of the plurality of reaction sites;
summating all corrected current values to generate an area under the curve (AUC) value; and
normalizing the AUC value to the background current value to generate a normalized AUC value.

29. The system of claim 28, wherein the computing device is configured to determine at least one of the fill rate, the liquid level, or the fill percentage of the fluid in the flow cell by comparing the normalized AUC value to a calibration curve of the normalized AUC values, wherein the calibration curve is generated by plotting two or more normalized AUC values of two or more known fill conditions.
